(19) United States
(12) Patent Application Publication
(10) Pub. No.: US 2026/0109147 A1
(43) Pub. Date: Apr. 23, 2026

(54) AN ACTUATOR COMPONENT FOR A DROPLET EJECTION HEAD AND METHOD FOR MANUFACTURING THE SAME

(71) Applicant: XAAR TECHNOLOGY LIMITED, Huntingdon, Cambridgeshire (GB)

(72) Inventors: Jürgen BRÜNAHL, Huntingdon, Cambridgeshire (GB); Renzo TRIP, Huntingdon, Cambridgeshire (GB); Ingo REINHOLD, Huntingdon, Cambridgeshire (GB); Nicholas Marc JACKSON, Huntingdon, Cambridgeshire (GB); Peter BOLTRYK, Huntingdon, Cambridgeshire (GB)

(21) Appl. No.: 19/116,856

(22) PCT Filed: Sep. 29, 2023
(86) PCT No.: PCT/GB2023/052530

§ 371 Date: Mar. 28, 2025

(30) Foreign Application Priority Data
Sep. 30, 2022 (GB) 2214373.9
Sep. 30, 2022 (GB) 2214375.4

(51) Int. Cl. B41J 2/14

(52) U.S. Cl. CPC B41J 2/14209; B41J 2202/02

(57) ABSTRACT

An actuator component for a droplet ejection head. The actuator component includes an actuator assembly and a nozzle plate. The actuator assembly includes a plurality of liquid chambers arranged in a liquid chamber array and a plurality of gas channels arranged in a gas channel array. The nozzle plate includes a plurality of ejection nozzles arranged in a nozzle array and a plurality of gas orifices arranged in an orifice array wherein the gas orifices and the ejection nozzles are arranged in a repeating pattern. Each liquid chamber is fluidically connected to one or more of the ejection nozzles and is actuable for the ejection of liquid droplets from the ejection nozzles. The plurality of gas channels is fluidically connected to a respective gas orifice(s). During use, gas flowing through the gas orifices controls one or more properties of the liquid ejected from the ejection nozzles.

The present disclosure relates to an actuator component for a droplet ejection head. The actuator component may be particularly suitable for use in a droplet ejection head that is a drop-on-demand ink-jet printhead, or, more generally, for use in a droplet ejection apparatus and, specifically, a droplet ejection apparatus comprising one or more actuator components or a droplet ejection apparatus comprising one or more droplet ejection heads comprising one or more actuator components as described herein. The actuator component provides an array of liquid chambers, which each have an actuator, which may be a piezoelectric actuator element, and a nozzle. The piezoelectric element may, for example, comprise lead zirconate titanate (PZT), but any suitable material may be used. The actuator is operable to cause the release, in an ejection direction, of liquid droplets through the nozzle in response to electrical signals. The actuator component further provides an array of gas channels, with gas channels having a respective gas orifice. The actuator component is operable to enable a flow of gas through said gas orifices so as to control the behaviour or properties of the liquid droplets. The present disclosure further relates to a method of operation of a droplet ejection apparatus and to a method of manufacture for an actuator component for a droplet ejection head.

### BACKGROUND

Droplet ejection heads are now in widespread usage, whether in more traditional applications, such as inkjet printing, or in 3D printing, or other rapid prototyping techniques. Accordingly, the liquids, e.g., inks, may have novel chemical properties to adhere to new substrates and increase the functionality of the deposited material. Droplet ejection heads have been developed that are capable of use in industrial applications, for example, for printing directly onto substrates, such as ceramic tiles or textiles or to form elements, such as colour filters in LCD or OLED displays for flat-screen televisions. Such industrial printing techniques using droplet ejection heads allow for short production runs, customization of products and even printing of bespoke designs. It will therefore be appreciated that droplet ejection heads continue to evolve and specialise so as to be suitable for new and/or increasingly challenging applications. However, while a great many developments have been made in the field of droplet ejection heads, there remains room for improvements.

In recent years, there has been increasing interest in printing at greater distances from the substrate to be printed on, increasing the so-called throw distance from droplet ejection head to substrate. There is also interest in controlling the properties of the environment around the droplets, so as to provide favourable conditions or to mitigate unfavourable conditions.

### SUMMARY

Traditional markets, such as ceramics, and new applications, such as direct-to-shape (DTS), demand an ever-increasing distance between the printhead and substrate, i.e., throw distance. A larger throw distance may result in a larger drop placement error, which can partially be explained by the increased time-in-flight of droplets. A larger throw distance may also cause an increased woodgrain effect, which is the result of a complex flow that exists in the gap between the nozzle plate and the substrate due to the interaction between the airflow induced by the drop curtain (e.g., the ejected droplets) and the airflow induced by the moving substrate. An obvious way to reduce the time-in-flight is to increase the (initial) drop velocity. However, the drop velocity is limited by the available drive voltage (and increasing this may have undesirable side effects, such as increased heating), and the formation of satellite droplets above a certain critical velocity, which is typically 5 m/s. Furthermore, an increased drop velocity may lead to a stronger interaction between the air flow induced by the drop curtain and the air flow induced by the moving substrate. Possible solutions used previously may include increasing the spacing between the nozzles, either in the print direction or the cross-print direction, but this undesirably reduces the print density and hence the image quality.

The present invention proposes a method to mitigate the effects of increased throw distance and avoid woodgrain effect by altering the complex flow around the ejected droplets, by sucking away, or blowing in, gas through gas orifices adjacent to the nozzles.

Another area of interest is controlling the droplets' properties. Such control may comprise controlling the humidity, or the temperature, or the amount of oxygen present, or otherwise providing favourable conditions (or mitigating unfavourable conditions) such that the droplets' composition or performance is controlled. For example, the aim may be to reduce evaporation of solvent or carrier fluid from a droplet in flight, so as to control the droplet's behaviour in flight or when it is drying on a substrate. Or the aim may be to reduce or prevent oxidation or solidification happening in flight, by altering the oxygen balance in the atmosphere surrounding the droplets. Still further, the aim may be to shield the droplets from dust particles in dusty environments.

The present invention proposes a method to alter the complex flow around the ejected droplets by sucking away or blowing in gas through gas orifices adjacent to the nozzles and/or to provide an apparatus suitable for further controlling the environment in the vicinity of the droplets and/or the composition of the droplets in flight and/or on the substrate. This may be in addition to or instead of mitigating woodgraining effects.

Aspects of the invention are set out in the appended independent claims, while details of particular embodiments of the invention are set out in the appended dependent claims.

According to a first aspect of the invention there is provided an actuator component for a droplet ejection head comprising:
an actuator assembly and a nozzle plate; wherein said actuator assembly comprises a plurality of liquid chambers arranged in a liquid chamber array extending in an array direction;
   wherein said plurality of liquid chambers are arranged to be fluidically connectable to a liquid supply; and
   a plurality of gas channels arranged in a gas channel array extending in said array direction;
   wherein said plurality of gas channels are arranged to be fluidically connectable to a gas supply;
   wherein said liquid chamber array and said gas channel array are fluidically independent from each other;
   wherein said nozzle plate comprises a plurality of droplet ejection nozzles arranged in a nozzle array extending in the array direction;
   and a plurality of gas orifices arranged in an orifice array extending in the array direction;
   wherein said gas orifices and said droplet ejection nozzles are arranged in a repeating pattern extending in the array direction;
   wherein each liquid chamber is arranged to be fluidically connected to one or more of said droplet ejection nozzles and actuable for ejection of droplets of a liquid;
   wherein said plurality of gas channels are arranged to be fluidically connected to respective one or more gas orifices for flow of a gas; and
   wherein said actuator component is configured such that in use gas flowing through said gas orifices controls one or more properties of the liquid ejected from said droplet ejection nozzles.

According to a second aspect of the invention there is provided a droplet ejection apparatus comprising one or more actuator components according to the first aspect; and further comprising a liquid supply and a gas supply wherein said gas supply may be arranged to be a positive or negative gas supply.

According to a third aspect of the invention a method of operating the droplet ejection apparatus according to the second aspect is provided comprising:
ejecting droplets of liquid from one or more of said droplet ejection nozzles in accordance with printing instructions; and
flowing gas through said gas orifices so as to control the droplets of said liquid ejected from said droplet ejection nozzles.

According to a fourth aspect of the invention a method of manufacturing an actuator component for a droplet ejection head according to the first aspect is provided, wherein said method comprises the steps of:
forming an actuator assembly, comprising:
forming one or more arrays of liquid chambers in one or more strips of piezoelectric material extending in an array direction,
   wherein each of said liquid chambers forms an open channel in the strip of piezoelectric material being open in a liquid chamber height direction and open at both ends in a liquid chamber extension direction;
forming one or more arrays of gas channels in said one or more strips of piezoelectric material extending in said array direction,
   wherein each of said gas channels forms an open channel in the strip of piezoelectric material being open in the liquid chamber height direction and open at both ends in the liquid chamber extension direction;
   wherein said liquid chamber array and said gas channel array are fluidically independent from each other; and
fixedly attaching a nozzle plate to the actuator assembly; and
forming droplet ejection nozzles and gas orifices in said nozzle plate either before or after the step of fixedly attaching the nozzle plate to the actuator assembly such that when assembled said actuator component comprises droplet ejection nozzles fluidically connected to said liquid chambers and gas orifices fluidically connected to said gas channels,
   wherein said gas orifices and said droplet ejection nozzles are arranged in a repeating pattern extending in the array direction.

### BRIEF DESCRIPTION OF THE DRAWINGS

FIG. 1A depicts a schematic representation of an actuator component for a droplet ejection head according to an embodiment, with one side removed so as to show some of the fluid paths (liquid and gas) therein.

FIG. 1B depicts a schematic representation of a droplet ejection apparatus comprising an actuator component for a droplet ejection head according to the embodiment of FIG. 1A, with a further portion removed, the droplet ejection apparatus further comprising liquid and supply gas paths and liquid and gas supplies.

FIG. 2A depicts a schematic representation of a droplet ejection apparatus comprising a part of an actuator component for a droplet ejection head according to another embodiment, with one side removed so as to show details of the fluid paths (liquid and gas) therein, and liquid and supply gas paths and liquid and gas supplies.

FIG. 2B depicts part of the schematic representation of FIG. 2A, with further portions removed, indicated by AA and BB in FIG. 2A, so as to provide further detail on the fluid paths therein.

FIG. 2C depicts part of the schematic representation of FIG. 2B, with a further portion removed, indicated by CC in FIG. 2B, so as to provide further detail on the fluid paths therein.

FIG. 3A depicts an actuator component, showing the nozzle plate, similar to that of FIG. 1A and FIG. 1B, where the gas orifices are offset in the y-direction with respect to the nozzles.

FIG. 3B depicts an actuator component, showing the nozzle plate, similar to that of FIG. 3A, but where the gas orifice exits are circular and smaller than the droplet ejection nozzles and where the gas channels are narrower in the array direction than the liquid chambers.

FIG. 3C depicts an actuator component, showing the nozzle plate, where the gas orifice exits are circular and larger than the droplet ejection nozzles and there is more than one gas orifice exit per gas channel, with the gas orifices being offset in the y-direction from the nozzles.

FIG. 3D depicts an actuator component, showing the nozzle plate, where the nozzles are staggered in the y-direction and larger than the gas orifice exits and where there is more than one gas orifice exit per gas channel such that each nozzle is located adjacent to a plurality of gas orifices, further where the gas channels are narrower in the array direction than the liquid chambers.

FIG. 3E depicts an actuator component, showing the nozzle plate, where the nozzles are staggered in the y-direction and larger than the gas orifice exits and where there is more than one gas orifice exit per gas channel such that each nozzle is located adjacent to a plurality of gas orifices, where the gas orifices are arranged radially around the nozzles.

FIG. 4 depicts an actuator component, similar to the embodiment of FIG. 2A-FIG. 2C but where there are two gas manifolds and a plurality of gas ports and a plurality of fluid inlets and fluid outlets.

FIG. 5 is a schematic drawing of a droplet ejection apparatus comprising an actuator component according to an embodiment and a movement device;

FIG. 6A depicts a first step in a manufacturing process for an actuator component according to an embodiment, comprising forming a cut-out in one or more strips of piezoelectric material and fixedly attaching the strip(s) of piezoelectric material to a substrate so as to form a gas manifold.

FIG. 6B depicts a second step in a manufacturing process for an actuator component according to an embodiment, comprising forming one or more arrays of gas channels in the one or more strips of piezoelectric material so as to create a plurality of open-ended gas channels in said one or more strips of piezoelectric material, wherein the gas channels are aligned in an array direction along the one or more strips of piezoelectric material.

FIG. 6C depicts a third step in a manufacturing process for an actuator component according to an embodiment, comprising forming one or more cover parts that are conformal to at least some of said one or more strips of piezoelectric material and at least some of said substrate, and fixedly attaching them to said one or more strips of piezoelectric material and at least some of said substrate.

FIG. 6D depicts a fourth step in a manufacturing process for an actuator component according to an embodiment, comprising forming the liquid chambers such that they are continuous through the cover part and the strips of piezoelectric material and form an open channel in the strip of piezoelectric material and in the cover part.

FIG. 6E depicts a fifth step in a manufacturing process for an actuator component according to an embodiment, comprising attaching a nozzle plate to the actuator assembly to form the actuator component.

FIG. 7 depicts a schematic representation of a section of an actuator component according to another embodiment, similar to that of FIG. 2C, comprising two thermal control fluid manifolds.

FIG. 8 is a schematic drawing of a droplet ejection apparatus comprising an actuator component according to an embodiment such as that of FIG. 7 and a movement device.

It should be noted that the drawings are not to scale and that certain features may be shown with exaggerated sizes so that these are more clearly visible.

### DETAILED DESCRIPTION OF THE DRAWINGS

Embodiments and their various implementations will now be described with reference to the drawings. Throughout the following description, like reference numerals are used for like elements where appropriate.

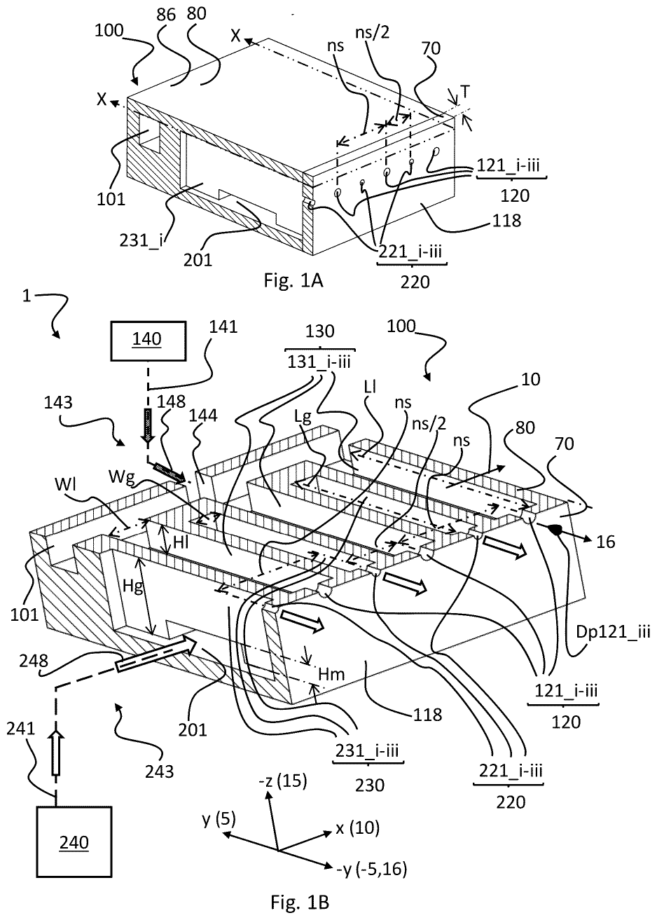

FIGS. 1A and 1B depict a schematic representation of an actuator component 100 for a droplet ejection head according to an embodiment. In FIG. 1A, one side of the actuator component 100 has been removed so as to show some of the fluid paths (liquid and gas) therein. FIG. 1B further depicts a droplet ejection apparatus 1 comprising the actuator component 100 of FIG. 1A. The actuator component 100 of FIG. 1B is shown schematically, with the top removed, as indicated by dotted lines XX in FIG. 1A, to allow more of the internal fluid paths to be seen.

The actuator component 100 comprises a nozzle plate 70 and an actuator assembly 80. The nozzle plate 70 has a thickness T. It can be seen from FIG. 1A that the nozzle plate 70 comprises a plurality of droplet ejection nozzles 121 (hereinafter referred to as nozzles), through which liquid may be ejected, arranged in a nozzle array 120 and a plurality of gas orifices 221 arranged in an gas orifice array 220. Both the nozzles 121 and the gas orifices 221 extend in a straight line in an array direction 10, and the nozzles 121 and the gas orifices 221 are arranged in a regularly spaced alternating pattern in the array direction 10.

The actuator assembly 80 comprises a plurality of liquid chambers 131 arranged in a liquid chamber array 130, where respective liquid chambers 131 are fluidically connected to one or more nozzles 121. The actuator assembly 80 further comprises a plurality of gas channels 231 arranged in a gas channel array 230, where respective gas channels 231 are fluidically connected to one or more gas orifices 221. The actuator assembly 80 may comprise one or more parts made from piezoelectric material. For example, one or more of the walls of the respective liquid chambers 131 may comprise piezoelectric material that is actuable, so as to eject liquid through a respective nozzle 121 in response to print instructions. It may be understood that this is by no means limiting and other devices or methods may be used to cause ejection of liquid through a respective nozzle 121.

The actuator component 100 of FIG. 1A is a so-called end shooter actuator where the nozzle plate 70 and the nozzles 121 are located at one end of the liquid chambers 131 in the liquid chamber extension direction 5. It can be seen that the nozzle plate 70 is located so as to fluidically seal the liquid chambers 131 and the gas channels 231, in the liquid chamber extension direction 5. It can further be seen that in this arrangement the droplet ejection direction 16 is aligned with the liquid chamber extension direction 5 and the negative y-direction. It may be understood that, in general, in operation, the media facing surface 118 will be appropriately aligned with the media such that droplets ejected in the ejection direction 16 land in the desired location on the media.

The nozzles 121 are separated by a nozzle spacing ns and the gas orifices 221 are also separated by the nozzle spacing ns, such that the separation between a nozzle 121 and its adjacent gas orifice 221 is ns/2, e.g. the centres of substantially all of the gas orifices 221 are spaced apart from the centre of the adjacent droplet ejection nozzle 121 in the array direction 10. The nozzle spacing ns in the array direction 10 may be conveniently measured from the centre of a nozzle 121 or gas orifice 221 to the centre of the adjacent nozzle or gas orifice, as appropriate. In some arrangements the centres of substantially all of the gas orifices 221 are spaced apart from the centre of the nearest droplet ejection nozzle 121 by a nozzle spacing ns/2 in the array direction 10. In the actuator component 100 both the nozzles 121 and the gas orifices 221 have a circular exit, e.g., the gas orifices 221 of FIG. 1A have substantially the same shape as the nozzles 121. However, it can be seen that the gas orifices 221 have a smaller cross-sectional exit area than the nozzles 121, though it may be understood that this is not limiting, and other arrangements may have the same cross-sectional areas at exit for both, or the gas orifices 221 may have a larger cross-sectional exit area than the nozzles 121. For clarity, it may be understood that the exits of the nozzles and orifices are located in the media-facing surface 118 of the nozzle plate 70.

In the embodiment of FIG. 1A the nozzle array 120 comprises 3 nozzles, 121_i-121-iii, and the gas orifice array 220 comprises 3 gas orifices 221_i-221_iii. It may be understood that this is by no means limiting, in other arrangements the nozzle array 120 may comprise one or more nozzles, and the gas orifice array 220 may comprise one or more gas orifices 221. The nozzle array 120 may comprise 121_i-121_n nozzles where n is any whole number and the gas orifice array 220 may comprise 221_i-221_m gas orifices, where m is any whole number. The nozzles may be substantially identical to each other, or identical to each other within the limitations of manufacturing capabilities. Likewise, the gas orifices may be substantially identical to each other, or identical within the limitations of manufacturing capabilities.

For simplicity, the actuator assembly 80 is shown as a monolithic part, but the skilled person would understand that it may comprise several parts, joined together in any suitable manner. Alternatively, it may be understood that, for example, additive manufacturing techniques such as 3D printing may be used to manufacture some or all of the actuator assembly 80, or some or all of the actuator component 100 as a single piece. It can be seen that the actuator assembly 80 has a liquid manifold 101, which is fluidically connected to the liquid chambers 131 (not shown in FIG. 1A) and a gas manifold 201 fluidically connected to the array of gas channels 230 and, hence, to each respective gas channel 231 (as seen from the cross-section through the first gas channel 231_i). It can also be seen that the gas channel 231_i is fluidically connected to the gas orifice 221_i.

In this embodiment, the gas manifold 201 is located below the liquid chambers 131 in the z-direction, the z-direction being anti-parallel to the liquid chamber (and gas channel) height direction 15. The gas manifold 201 is also located at the base of the gas channels 231 in the liquid chamber height direction 15, so that it intersects with and is fluidically connected to them.

It may be generally understood that this spatial arrangement is by no means essential and other arrangements of gas manifold 201 relative to the liquid chambers 131 may be envisioned. Further, any suitable spatial arrangement of the gas manifold 201 relative to the liquid manifold 101 may be utilised. It may be understood that such suitable spatial arrangements may be implemented providing that the gas manifold 201 is fluidically connected to the gas channel array 230 and the liquid manifold 101 is fluidically connected to the liquid chamber array 130 and that the gas path 243 and the liquid path 143 are kept fluidically separated from each other.

The liquid chambers 131 and the gas channels 231 may comprise one or more layers deposited on some or all of their internal surfaces, such as a metallic layer or layers to enable actuation of the piezoelectric material, and a protective coating layer or layers to prevent fluids such as inks from causing damage (e.g. corrosion) to the metallic layer(s) and/or to passivate the electronics. Therefore, the actuator component 100 comprises electrical traces and connections.

Turning now to FIG. 1B, the nozzles 121, gas orifices 221, nozzle array 120 and gas orifice array 220 are as described above with respect to FIG. 1A. For simplicity, in FIG. 1B the actuator component 100 has been depicted as a single part, with the locations of the nozzle plate 70 and the actuator assembly 80 indicated, but it may be understood that the actuator component 100 in FIG. 1B comprises two separate parts as in FIG. 1A. The actuator component 100 comprises an array 130 of liquid chambers extending in the array direction 10. The array 130 of liquid chambers 131 comprises a plurality of liquid chambers 131. The liquid chambers (131_i-131_iii) extend side-by-side in the array direction 10; said array direction 10 being generally perpendicular to a liquid chamber height in the liquid chamber height direction 15. Each liquid chamber 131 is elongate in a liquid chamber extension direction 5 which in this embodiment is perpendicular to the liquid chamber height direction 15. More generally the liquid chambers 131 are elongate in a liquid chamber extension direction 5 non-parallel to the liquid chamber height Hl, and each liquid chamber 131 opens into the liquid manifold 101, at a first end, in the liquid chamber extension direction 5.

In this embodiment the liquid chamber extension direction 5 is perpendicular to the array direction 10, but this is by no means essential and, in other arrangements, the liquid chamber extension direction 5 may be at a different angle, for instance so as to enable longer liquid chambers within a given droplet ejection head footprint. Thus, more generally, the liquid chamber extension direction 5 may be at an angle other than 90° to the array direction 10.

The actuator component 100 further comprises an array 230 of gas channels 231 extending in the array direction 10. The plurality of gas channels 231_i-231_iii extend side-by-side in the array direction 10. Each gas channel 231 is elongate in the liquid chamber extension direction 5, which is at an angle to the array direction 10. The liquid chambers 131 and the gas channels 231 extend side-by-side in the array direction 10 such that they are arranged parallel to each other, but this is by no means essential and other arrangements may be envisaged. In this implementation, the array direction 10 is perpendicular to the liquid chamber extension direction 5, but it should be understood that this is by no means essential and, in other implementations, the liquid chambers 131 may be arranged at an angle other than 90° to the array direction, e.g. they may be elongate in a direction non-parallel to the array direction 10. Likewise, the gas channels 231 may be elongate in a direction non-parallel to the array direction 10.

The liquid chambers 131 have a width Wl in the array direction 10 and a height Hl in a liquid chamber height direction 15 (the negative z-direction). Similarly, the gas channels 231 have a width Wg in the array direction 10 and a height Hg in the liquid chamber height direction 15. Each gas channel 231 opens into the gas manifold 201 at its base in the liquid chamber height direction 15. So that the gas channels 231 can fluidically connect to the gas manifold 201 without the liquid chambers impinging onto the gas manifold 201, height Hg is greater than height Hl (Hg>Hl) e.g., in order to achieve fluidic independence the gas channels 231 are deeper than the liquid chambers in the liquid chamber height direction 15. Further, because in this arrangement the gas manifold 201 intersects the gas channels 231 (see cross-section of 231_i, for example) the gas channel height Hg minus the gas manifold height Hm is greater than the liquid chamber height Hl (Hg−Hm>Hl). Still further, in this arrangement, in order to prevent the gas channels 231 impinging on the liquid manifold 101, the gas channels 231 are shorter in the liquid chamber extension direction 5 than the liquid chambers 131 (Lg<Ll).

The droplet ejection apparatus 1 of FIG. 1B may comprise one or more actuator components as described herein. More generally the droplet ejection apparatus 1 may comprise one or more droplet ejection heads comprising one or more actuator components as described herein. The droplet ejection apparatus 1 may further comprise liquid and gas supplies 140 and 240 respectively. The liquid supply 140 may be fluidically connectable to the nozzles 121 via a liquid path 143 and the gas supply 240 may be fluidically connectable to the gas orifices 221 via a gas path 243. The liquid supply 140 may be fluidically connected to a liquid reservoir 146. The gas supply 240 may be arranged to be a positive or negative gas supply, which means that it may supply gas to the gas orifices 221 (positive gas supply) or draw gas through the gas orifices 221 into the actuator component 100 (negative gas supply). The gas supply 240 may be fluidically connected to a gas reservoir 246.

It can be seen that the liquid path 143 comprises an inlet liquid path 141 fluidically connecting the liquid supply 140 to a liquid inlet 144 in the actuator component 100 (as indicated by shaded arrows 148). In the actuator component 100 the liquid path 143 comprises a liquid manifold 101 that is fluidically connected to the plurality of liquid chambers 131, arranged in a liquid chamber array 130, with each liquid chamber 131 being fluidically connected to a nozzle 121. As previously mentioned, the actuator component 100 of FIG. 1A and FIG. 1B is a so-called end shooter actuator component where the nozzles 121 are located at one end of the liquid chambers 131. In the embodiment of FIG. 1A and FIG. 1B the ejection direction 16 is in the negative-y-direction, further, it is aligned with the longitudinal liquid chamber direction 5 and perpendicular to the array direction 10. The liquid chambers 131 each comprise at least one actuator, which may be a piezoelectric actuator element, and at least one nozzle 121. The respective actuators for each liquid chamber 131 are operable to cause the release, in the ejection direction 16, of one or more liquid droplets through the respective nozzle 121 in response to electrical signals (as indicated by droplet Dp121_iii, ejected from nozzle 121_iii, in FIG. 1B).

It can further be seen that in the apparatus 1 of FIG. 1B the gas path 243 comprises a gas path 241, which is fluidically connectable between the gas supply 240 and the actuator component 100 (see white arrows 248). In the actuator component 100, the gas path 243 comprises a gas manifold 201 that is fluidically connected to the plurality of gas channels 231, with each gas channel 231 being fluidically connected to a gas orifice 221. In other words, the gas channels 231 are fluidically connectable via the gas manifold 201 to the gas supply 240. As previously mentioned, the gas supply 240 may be arranged to be a positive or negative gas supply being operable to cause a flow of gas, through the gas orifices 221, in a positive or negative direction (respectively out of, or into, the gas orifices 221). There may be one or more gas ports 244 (not shown) to connect the gas path 241 to the gas manifold 201 and in operation to enable supply of gas to the gas manifold 201 from the gas path 241, or to remove gas from the gas manifold 201 and hence to the gas path 241, depending on whether the gas supply 240 is operating as a positive or negative gas supply.

The liquid path 143 and the gas path 243 are fluidically separated from each other, ensuring that there is no mixing of the two fluids at any stage between the liquid supply 140 and the exits of the nozzles 121 or at any stage between the gas supply 240 and the exits of the gas orifices 221. In other words, the liquid path 143 and the gas path 243 are both fluid tight and separate (or fluidically independent) from each other. As part of this, as described in greater detail above, the heights Hl of the liquid chambers 131 and heights Hg of the gas channels 231 are different, as are their respective lengths Ll and Lg where the gas manifold 201 is located below the liquid chambers 131 in the negative liquid chamber height direction 15. In embodiments where the actuator is a shear mode piezoelectric actuator, an additional advantage of keeping the two paths fluidically independent is that, for droplet ejection heads where the fluid is an aqueous (i.e., water-based) fluid, some or all of the drive electrodes for driving individual actuators may be located in the gas channels 221. In this way they are physically isolated from contact with the fluid, such as ink, reducing or preventing electrical shorts.

In operation the apparatus 1 may comprise liquid flowing from the liquid supply 140, via the liquid path 143 to the exits of the nozzles 121. For example, liquid may flow from the liquid supply 140, via the inlet liquid path 141 and into a droplet ejection head comprising the actuator component 100. The liquid enters the actuator component 100 and enters the liquid manifold 101 via the liquid inlet 144. From the liquid manifold 101 the liquid enters the respective liquid chambers 131 at one end and flows along them in the liquid chamber extension direction 5. In other words, the actuator component 100 for a droplet ejection head comprises one or more liquid manifolds 101; where the liquid chambers (131_i-o) are fluidically connectable via said one or more liquid manifolds (101,102) to the liquid supply 140.

Then, in accordance with printing instructions the droplet ejection apparatus 1 may eject droplets of liquid from one or more of the nozzles 121 (in the ejection direction 16). At the same time, the droplet ejection apparatus 1 may cause gas to flow through the gas orifices 221 so as to control the liquid droplets ejected from the nozzles 121. Such control may be to control the droplet trajectory, or to otherwise control the environment around the droplets or the droplet behaviour or composition.

Depending on the type of gas supply 240, or on the mode of operation of the gas supply 240, the apparatus 1 may be arranged such that gas flows from the gas supply 240, via the gas path 243 and through the gas orifices 221 in the ejection direction 16 (e.g. out of the gas orifices 221) so as to control the liquid droplets; such a gas supply 240 may be termed a “positive gas supply” 240. Alternatively the apparatus 1 may be arranged such that the gas supply 240 causes gas to flow through the gas orifices 221 in the negative ejection direction 16 (e.g. from outside the actuator component 100, through the gas orifices 221, and into the actuator component 100) and to the gas supply 240, via the gas path 243, so as to control the liquid droplets. Such a gas supply 240 may be termed a “negative gas supply” 240.

Without wishing to be bound to any particular theory, the inventors suggest that, to appreciate the effect of a positive gas flow for control of the droplet trajectories, the Stokes' drag should be considered. The Stokes' drag is a force acting on a small spherical object, such as a droplet, when it is in motion relative to a surrounding medium. As a result of the Stokes' drag, the velocity of the droplet will decrease from the initial drop velocity at the nozzle plate 70 to a minimum at the substrate. The proposed solutions described herein may aim to increase the drop velocity by reducing the difference in velocity between the droplet and the surrounding medium.

In a typical situation, without control, the air in the near vicinity of the droplet only moves in the direction of droplet ejection because momentum is transferred from the droplet to the air, i.e., because the droplet is slowed down. By ejecting a gas through the gas orifices 221 adjacent to the nozzles 121, the relative motion between the droplet and the surrounding medium is reduced, since the surrounding medium is moving in the same direction, and less momentum is transferred. In some arrangements, the gas velocity, as it exits the gas orifices, may be less than the droplet ejection velocity (the initial drop velocity). In other arrangements the droplet velocity may be increased by ejecting a gas through the gas orifices 221 at a velocity that exceeds the initial drop velocity. In some arrangements, the gas velocity may be controlled so that it acts to reduce or prevent satellite formation from the liquid droplets, or such that satellite formation is delayed beyond the threshold velocity at which it normally occurs. In other arrangements, the satellite formation threshold may be the limiting gas velocity.

If the induced velocity of the surrounding medium is significant, compared to the relative motion between the droplet ejection head and the substrate (both droplet ejection head and substrate may be in motion), then the ejected gas may also have a noticeable positive effect on the complex flow responsible for the woodgrain effect.

In still other arrangements, gas may be drawn through the gas orifices 221 into the actuator component. It may be understood that, whether the gas is blown through the orifices or drawn into the actuator component, may be decided depending on the particular circumstances and operating conditions and configuration of droplet ejection head, droplet ejection velocity, print duty cycle, substrate speed and/or droplet ejection head speed, etc. It may be understood that, adding a tertiary flow, e.g., the gas flow, (whereby the primary flow is generated by the ejected droplets, and the secondary flow is induced by the moving substrate/printhead), will allow for positively affecting the complex flow between the droplet ejection head and the substrate.

In other arrangements, the gas supply 240 may be used to supply a gas with particular properties, such as an inert gas, that reduces the exposure of the droplets to oxygen and, therefore, alters the rate of reaction of any oxygen-reactive compounds in the droplets (thereby altering drying times on a substrate, for example). Alternatively, using a gaseous form of a solvent, where the solvent is also a component of the liquid being ejected, may alter the solvent evaporation rates from the droplets and favourably alter the droplet drying rates, for example.

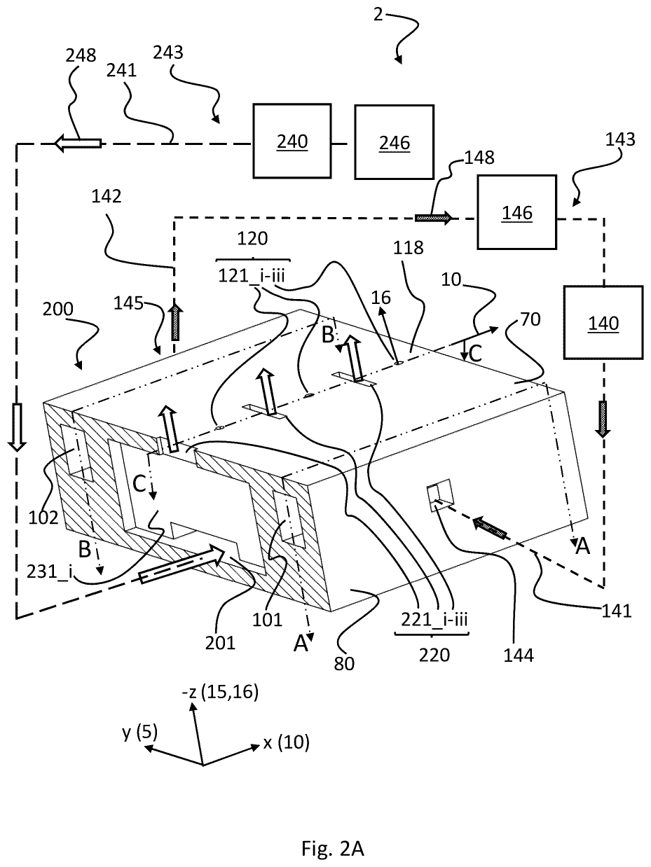

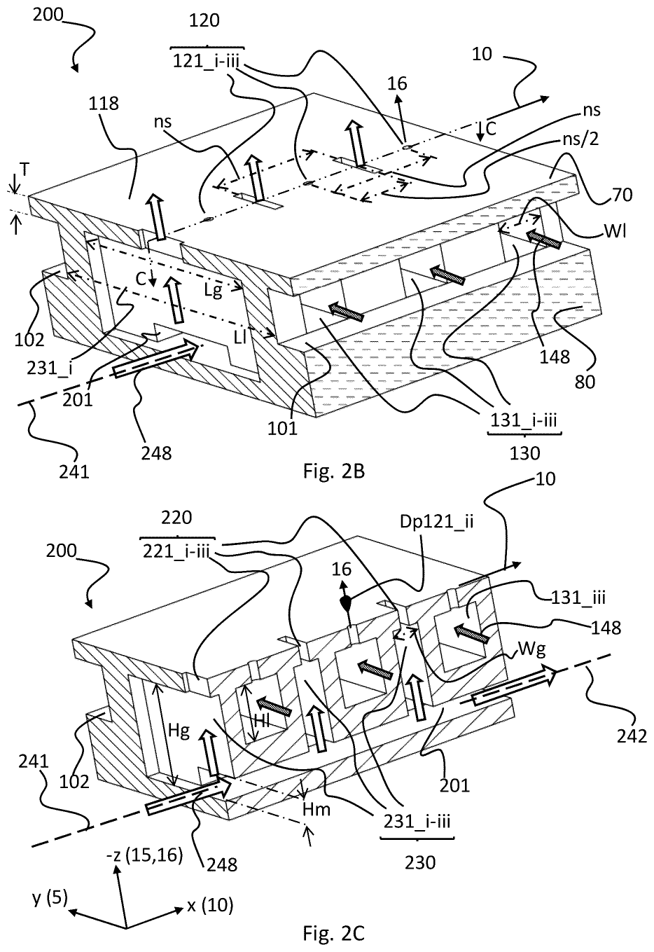

Turning now to FIG. 2A, this depicts a schematic representation of a droplet ejection apparatus 2 comprising an actuator component 200 for a droplet ejection head, according to another embodiment. It can be seen that this actuator component 200 is a side shooter actuator component, where the ejection direction 16 is in the liquid chamber height direction 15, as compared to the end shooter actuator component 100 of FIG. 1A and FIG. 1B where the ejection direction 16 is in the liquid chamber extension direction 5. As in the apparatus 1 of FIG. 1B, the apparatus 2 also comprises liquid and gas paths 143,243 and liquid and gas supplies 140,240 respectively. One side of the actuator component 200 has been removed so as to show some details of the fluid paths. As in FIG. 1B, the actuator component 200 is shown as single part, with the locations of the nozzle plate 70 and the actuator assembly 80 indicated, but it may be understood that the actuator component 200 may comprise two separate parts as in FIG. 1A, or more separate parts, as described above.

As can be seen in the cross-section through gas channel 231_i in FIG. 2A-FIG. 2C, the gas orifice 221_i is arranged part-way along the gas channels 231_i in the gas channel extension direction 5 (which in this arrangement is the same direction as the liquid chamber extension direction 5). The other gas orifices 221_ii-iii and gas channels 231_ii-iii are similarly arranged. Similarly, in this embodiment, the nozzles 121_i-iii are arranged part-way along their respective liquid chambers 131_i-iii (see FIG. 2C) in the liquid chamber extension direction 5, rather than on the ends of the liquid chambers as in the embodiment of FIG. 1A and FIG. 1B. Accordingly, the nozzle plate 70 is located on the top of the actuator component 200, rather than on one end as in FIG. 1A and FIG. 1B. It can further be seen that the nozzle plate 70 is located so as to fluidically seal the liquid chambers 131 and the gas channels 231, in the liquid chamber height direction 15. Still further, the ejection direction 16 is in the negative-z-direction, aligned with the liquid chamber height direction 15 and perpendicular to the array direction 10. As previously described, in general, in operation, the media facing surface 118 will be appropriately aligned with the media such that droplets ejected in the ejection direction 16 land in the desired location on the media.

It can also be seen that the actuator component 200 has what is generally known as a recirculation or through-flow design, whereby, in operation, it is fluidically connected with a liquid path 143 such that liquid flows from the liquid supply 140 via the liquid path to the actuator component 200 and then returns, via the liquid path 143, to the liquid supply 140 (as indicated by shaded arrows 148).

Parts of the liquid path 143 can be seen more clearly in FIG. 2B and FIG. 2C, which comprise details of the actuator component 200 of FIG. 2A, where parts have been removed as indicated by dash-dot lines AA, BB and CC. In operation, liquid travels from the liquid supply 140 via the inlet liquid path 141 to the liquid inlet 144, from where it is supplied to the liquid manifold 101. It may be understood that the liquid path 143 may comprise further fluidic components within a droplet ejection head, as well as fluidic connections external to the droplet ejection head and further fluidic components to carry the liquid away from the actuator component, out of the droplet ejection head and back to the liquid supply 140. From the liquid manifold 101 liquid is supplied to one end of the plurality of liquid chambers 131, in the liquid chamber extension direction 5. The respective actuators, for each liquid chamber 131 are operable to cause the release, in an ejection direction 16, of one or more liquid droplets through a respective nozzle 121 in response to electrical signals. For example, a print command may cause an electrical signal to be sent to an actuator in chosen liquid chamber 131_ii, causing the actuator to actuate and eject liquid via the respective nozzle 121_ii and form a droplet (as indicated by droplet Dp121_ii in FIG. 2C).

It may be understood that depending on the print instructions, at any given time there may be no nozzles 121 ejecting liquid, or one or more nozzles 121 may be caused to eject liquid, so as to form the required image. The remaining un-ejected liquid continues through the respective liquid chambers 131 in the liquid chamber extension direction 5 and exits the respective liquid chambers 131 at the opposite end to which it entered and hence enters into the liquid manifold 102. The liquid exits the liquid manifold 102 via one or more liquid outlets 145 (not shown). The liquid outlets 145 may also be the point at which the liquid exits the actuator component 200 and returns to the liquid supply 140 via the return liquid path 142. Alternatively, the return liquid path 142 may comprise further fluidic components within the actuator component 200 and/or within a droplet ejection head, as well as fluidic connections external to the droplet ejection head and further fluidic components to carry the liquid back to the liquid supply 140.

In some arrangements, whereby the actuator component 200 is for use in a recirculation droplet ejection head, there may be one or more arrays of liquid chambers 131 and one or more liquid manifolds 101,102 whereby at least one of said one or more liquid manifolds is an inlet liquid manifold 101 and at least one of said one or more liquid manifolds is an outlet liquid manifold 102 such that, in operation, liquid flows from said liquid supply 140, through said inlet liquid manifold 101, through said liquid chamber array 130 and returns to said liquid supply 140 via said outlet liquid manifold 102.

In other words, the liquid chambers 131 are open at opposing ends in the liquid chamber extension direction 5 and fluidically connected at a first end to liquid manifold 101 and at the second end to liquid manifold 102. When operating in recirculation mode liquid flows from inlet liquid manifold 101, via the respective first end of each liquid chamber 131, through the plurality of liquid chambers 131 and into the outlet liquid manifold 102 via the respective second end of each liquid chamber 131. In accordance with print instructions droplets may be ejected from one or more of the respective nozzles 121 in the array of nozzles 120 wherein said nozzles 121 are located part-way along the respective liquid chambers 131 in the liquid chamber extension direction 5.

Considering now the gas path 243, as shown in FIG. 2A this comprises a gas path 241 that connects the gas supply 240 to the actuator component 200. When the gas supply 240 is a positive gas supply it supplies gas to the gas orifices 221 for ejection in the ejection direction 16 (as indicated by white arrows 248) and the gas path 241 is an inlet gas path 241. Alternatively, when the gas supply 240 is a negative gas supply it draws gas through the gas orifices 221 and via the gas path 243 to the gas supply 240, in which case the gas path 241 is operating as a return gas path 241.

In some arrangements, as shown in FIG. 2C, gas path 243 of the droplet ejection apparatus 2 comprises a gas path 241 and a gas path 242, fluidically connected to the gas manifold 201. Where the gas supply 240 is a positive gas supply 240, the gas path 243 may be a recirculation path, such that the gas path 241 is an inlet gas path 241, and the gas path 242 is a return gas path 242. In such an arrangement, gas is supplied via the inlet gas path 241 to the gas manifold 201 and from there to the plurality of gas channels 231. Some of the gas flows through the gas orifices 221, with the remainder returning to the gas supply 240 via the return gas path 242. This may be a desirable arrangement in, for example, dusty environments, as the gas flow rate may be higher than a design without a return gas path, because only a proportion of the gas is flowing through the gas orifices 221. A higher flow rate may aid in the removal of unwanted particles that may otherwise enter and build up in the gas path of the actuator component 200.

Instead of operating in recirculation mode, both the gas path 241 and the gas path 242 may operate as inlet gas paths, supplying gas to the manifold 201 and from there to the plurality of gas channels 231. In some operating regimes a negative pressure may be induced at the gas orifice by having a positive flow at the back of the gas orifice in the gas channels 231. Alternatively, where the gas supply 240 is a negative gas supply then both the gas paths 241,242 may operate as return gas paths 241,242, drawing gas from either end of the actuator component 200, which may aid in providing more uniform suction through the gas orifices 221. Still further, where the gas supply 240 is a positive gas supply then both the gas paths 241,242 may operate as supply gas paths 241,242, supplying gas at either end of the actuator component 200.

It can further be seen that, as in FIG. 1A and FIG. 1B, the nozzles 121 and the gas orifices 221 of the actuator component 200 of FIG. 2A-FIG. 2C are arranged in an alternating relationship extending in the array direction (10). Further, they are arranged in a regularly spaced alternating pattern, with the nozzles 121 being separated by a nozzle spacing ns and the gas orifices 221 also being separated by the nozzle spacing ns, such that the separation between a nozzle 121 and its adjacent gas orifice 221 is ns/2 in the array direction 10, measured from centre to centre in the array direction 10. The gas orifices 221 and nozzles 121 of FIG. 2A-FIG. 2C are aligned at their centres in the liquid chamber extension direction 5. However, unlike the gas orifices 221 of FIG. 1A and FIG. 1B, which have substantially the same shape as the nozzles 121, the gas orifices 221 of FIG. 2A-FIG. 2C have an elongate shape, in this case being rectangular slots, and extend beyond the nozzles 121 in the positive and negative liquid chamber extension direction 5. Such an arrangement may allow the gas flow through the gas orifices 221 to create a greater ‘wall’ or gas curtain between adjacent nozzles 121 and reduce fluidic interactions between droplets ejected from adjacent nozzles 121. Such an arrangement may also reduce flooding on the nozzle plate 70 by reducing, or preventing, the spread of any leaks from one nozzle 121 to another, and so reduce nozzle blockages and improve reliability of the actuator component 200.

Various other features of the embodiment of FIG. 2A-FIG. 2C are as described above with respect to FIG. 1A and FIG. 1B, for example, in order to prevent the gas channels 231 impinging on the liquid manifolds 101,102, the gas channels 231 are shorter in the liquid chamber extension direction 5 than the liquid chambers 131 (Lg<Ll). Similarly, the gas channels 231 are deeper in the liquid chamber height direction 15, such that their height Hg is greater than the height Hl of the liquid chambers 131, Hg−Hm>Hl, where the gas manifold 201 is located below the liquid chambers 131 in the z-direction (or the negative liquid chamber (and gas channel) height direction 15). The gas manifold 201 is also located at the base of the gas channels 231 in the liquid chamber height direction 15 so that it intersects with and is fluidically connected to them. However, other arrangements may be envisaged provided that the gas manifold 201 is fluidically connected to the gas channels 221 and is fluidically separated from (i.e., not fluidically connected to) the liquid chambers 131 or the liquid path 143. It can further be seen that in this side shooter actuator arrangement, the gas manifold 201 opposes the nozzle plate 70, i.e., it is located on the opposite side of the gas channels 231 and liquid chambers 131 to the nozzle plate 70, in the liquid chamber height direction 15.

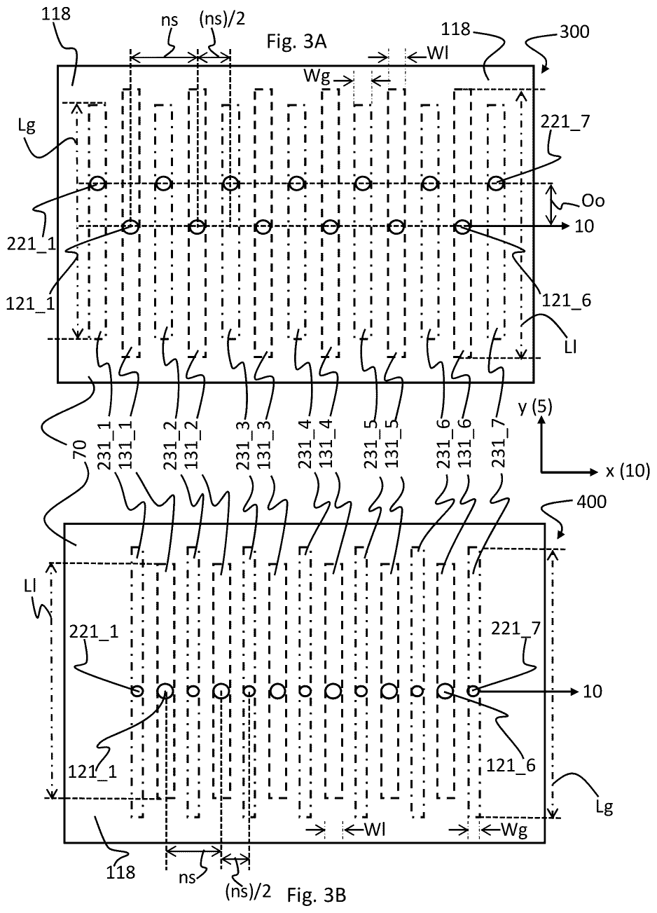

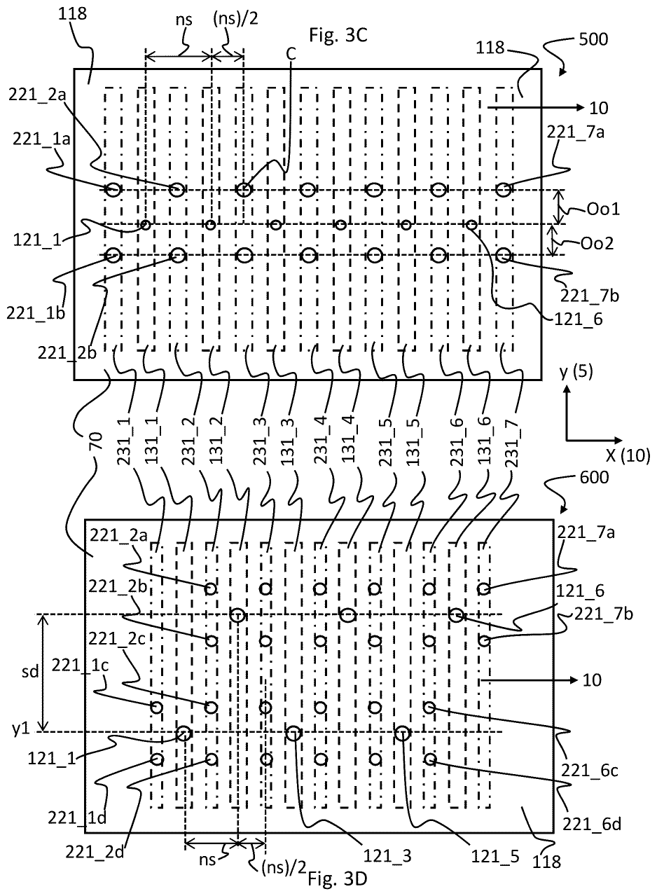

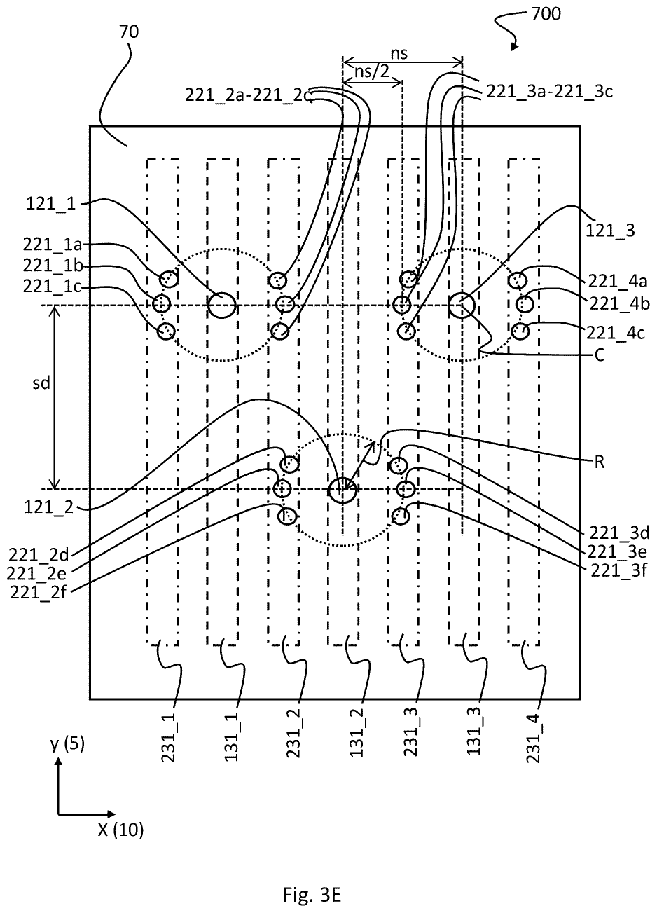

Turning now to FIG. 3A-FIG. 3E, these depict actuator components 300 to 600 viewed such that the media-facing surface 118 of the nozzle plates 70 can be seen, with the positions of the liquid chambers 131 and the gas channels 231 indicated by dashed lines. In FIG. 3A, whilst the gas orifices 221 and the nozzles 121 are equally spaced in the array direction 10, it can be seen that the gas orifices 221_1-221_7 are offset from the nozzles 121_1-121_6 in the positive y-direction (liquid chamber extension direction 5) by an offset distance Oo, such that the gas orifices 221 are spaced apart from the centres of the nozzles 121 in the liquid chamber extension direction 5. If the actuator component 300 is arranged in a droplet ejection apparatus 1,2,9, such that the positive y-direction is aligned with the media movement direction 109, then the gas orifice array 220 will be downstream of the nozzle array 120. Alternatively, if the actuator component 300 is arranged in a droplet ejection apparatus 1,2,9, such that the negative y-direction is aligned with the media movement direction 109, then the gas orifice array 220 will be upstream of the nozzle array 120.

It can also be seen that, as described above with reference to the embodiment of FIG. 2A-FIG. 2C, in the actuator component 300 of FIG. 3A the gas channels 231 are shorter than the liquid chambers 131 in the liquid chamber extension direction 5 such that Ll>Lg, so as to allow fluidic separation of the gas path 243 and the liquid path 143, by preventing the gas channels impinging on the liquid manifolds 101,102 (not shown in FIG. 3A).

Considering now FIG. 3B, it can be seen that the gas orifices 221 and the nozzles 121 are equally spaced in the array direction 10, and that there is no offset in the y-direction. However, it can be seen from the dashed lines that the gas channels 231 are narrower than the liquid chambers 131 in the array direction 10 (Wg<Wl). This reduces the nozzle spacing ns, for example compared to that of FIG. 3A (where Wg=Wl), and also reduces the separation ns/2 between a nozzle 121 and its adjacent gas orifice 221. Such an arrangement may be desirable because it increases the print resolution, since the nozzles 121 are closer together. The gas orifices 221 in FIG. 3B are also smaller than the nozzles 121, but this is not limiting. It may be understood that, depending on the relative gas and liquid flow rates required for a given application, the gas orifices 221 may be larger or smaller than the nozzles 121, where the width of the narrower gas channels 231 so allows. More generally, the gas orifices 221 may have a cross-sectional area greater or smaller than that of the nozzles 121, depending on the requirements of a particular application.

It can also be seen that, unlike the actuator component 300 of FIG. 3A, in the actuator component 400 of FIG. 3B the gas channels 231 are longer than the liquid chambers 131 in the liquid chamber extension direction 5, such that Ll<Lg, so as to allow fluidic separation of the gas path 243 and the liquid path 143 by preventing the gas channels impinging on the liquid manifolds 101,102 (not shown in FIG. 3B). In such an arrangement the gas path 243 may have two manifolds 201,202, one at either end of the gas channels 231 in the liquid chamber extension direction 5, fluidically connected so that, in use, gas can flow from the gas manifold 201, along the plurality of gas channels 231 in the liquid chamber extension direction 5 and then into the gas manifold 202. Such an arrangement may additionally have a single liquid manifold 101 below the liquid chambers 131 in the z-direction (e.g., similar to the arrangement of FIG. 2A to FIG. 2C but with the gas and liquid paths 143,243 swapped).

Alternatively, two liquid manifolds 101,102 may be arranged below the liquid chambers 131 in the liquid chamber height direction 15 and fluidically connected so that, in use, liquid can flow from the liquid manifold 101, along the plurality of liquid chambers 131 in the liquid chamber extension direction 5 and then into the liquid manifold 102. Alternatively, any other suitable arrangement of liquid manifolds 101,102 and gas manifolds 201,202 may be used, provided that the two fluidic paths 143,243 remain fluidically separated whilst allowing gas and liquid to be supplied to their respective plurality of gas channels 231 and plurality of liquid chambers 131. Where the arrangement of the gas path 243 is for a recirculation flow arrangement then gas may be removed from the plurality of gas channels 231 by any suitable fluidic paths, such as those described above with respect to FIG. 2A-FIG. 2C. Similarly, where the liquid path 143 is for a recirculation flow arrangement then liquid may be removed from the plurality of liquid chambers 131 using any suitable arrangement of fluidic paths.

Turning now to FIG. 3C, this depicts an arrangement similar to that of FIG. 3A, but where the actuator component 500 comprises two rows of gas orifices 221 (labelled a and b), offset in the positive and negative y-directions from the nozzles 121 by offsets Oo1 and Oo2 respectively, such that there are two or more gas orifices 221 per nozzle 121. It may be understood that this is not limiting and there may be plural gas orifices 221 per droplet ejection nozzle 121 such that the plural gas orifices 221 per droplet ejection nozzle 121 are spaced apart from the nozzle centre in the liquid chamber extension direction 5. This means that each gas channel 231 comprises two or more or plural gas orifices 221. The plural gas orifices 221 per droplet ejection nozzle 121 are also spaced apart from the nozzle centre in the array direction 10. Using this arrangement, the nozzles 121 may be surrounded by a greater amount of gas flow, enabling improved control of the droplet trajectories and/or the composition of the gas surrounding the droplets and hence the droplets' properties and/or behaviour, such as evaporation rates therefrom. Further, in FIG. 3C, the gas orifices 221 are larger in cross-sectional area than the nozzles 121, but this is by no means limiting, and other sizes of gas orifices may be used, as previously discussed.

Turning now to FIG. 3D, this depicts an arrangement similar to that of FIG. 3B, where the gas channels 231 are narrower than the liquid chambers 131. The main differences are that alternate nozzles 121 are staggered in the y-direction by a stagger distance sd, such that all the odd numbered nozzles 121_1,121_3, etc. are at one y-position y1, and all the even-numbered nozzles 121_2,121_4, etc. are at a y-position y1+sd. It can further be seen that each nozzle 121 is arranged adjacent to four gas orifices and that each gas channel 231 comprises four gas orifices 221 (labelled from a to d) except for gas channels 221_1 and 221_7 at the outermost edges of the gas channel array 230, in the array direction 10, which each comprise two gas orifices. In other words in the actuator component 600 of FIG. 3D there are at least two gas orifices 221 per droplet ejection nozzle 121 spaced apart from the nozzle centre in the array direction 10 and at least two gas orifices 221 per droplet ejection nozzle 121 spaced apart from the nozzle centre in the liquid chamber extension direction 5, such that the droplet ejection nozzle 121 is substantially surrounded by the gas orifices 221. Such an arrangement, with a plurality of gas orifices 221 per nozzle 121 may be beneficial where the flow speeds and/or the fluidic properties of the liquid, or the media speed, may be such that greater amounts of gas, or a greater number of gas orifices arranged around each nozzle so as to give control around a greater proportion of each nozzle circumference, are required to control the droplet speed or other properties of the droplet, such as controlling the humidity around the droplet.

It can be seen that in the actuator component 500 of FIG. 3C and the actuator component 600 of FIG. 3D the gas channels 231 and liquid chambers 131 are the same length in the liquid chamber extension direction 5. It may be understood that, as for previously described embodiments, any suitable arrangement of liquid and gas manifolds 101,102,201,202 may be used to supply liquid and gas to the respective gas channels 231 and liquid chambers 131, whilst maintaining the fluidic separation of the gas path 243 and the liquid path 143. For example, the liquid and gas manifolds may be located at different vertical heights in the z-direction, as may the liquid chambers 131 and gas channels 231, such that the fluidic paths 143,243 do not impinge on each other. Descenders, as are well known in the art, may be used in the fluidic paths 143,243 to fluidically connect the gas orifices 221 and/or the nozzles 121 to their respective gas channels 231 and liquid chambers 131. It may be understood, more generally, that any suitable arrangement of the fluidic paths 143,243 may be contemplated providing that fluidic separation of the two paths is maintained.

FIG. 3E depicts an actuator component 700, similar to that of FIG. 3D, showing the nozzle plate 70, where the nozzles 121 are staggered in the liquid chamber extension direction 5 and larger than the gas orifice 221 exits and where there is more than one gas orifice 221 per gas channel 231 such that each nozzle 121 is located adjacent to a plurality of gas orifices 221. Unlike FIG. 3D, in FIG. 3E there are plural gas orifices 221 arranged at a radius R from the centres C of the nozzles 121, such that the gas orifices 221 substantially surround the nozzles 121.

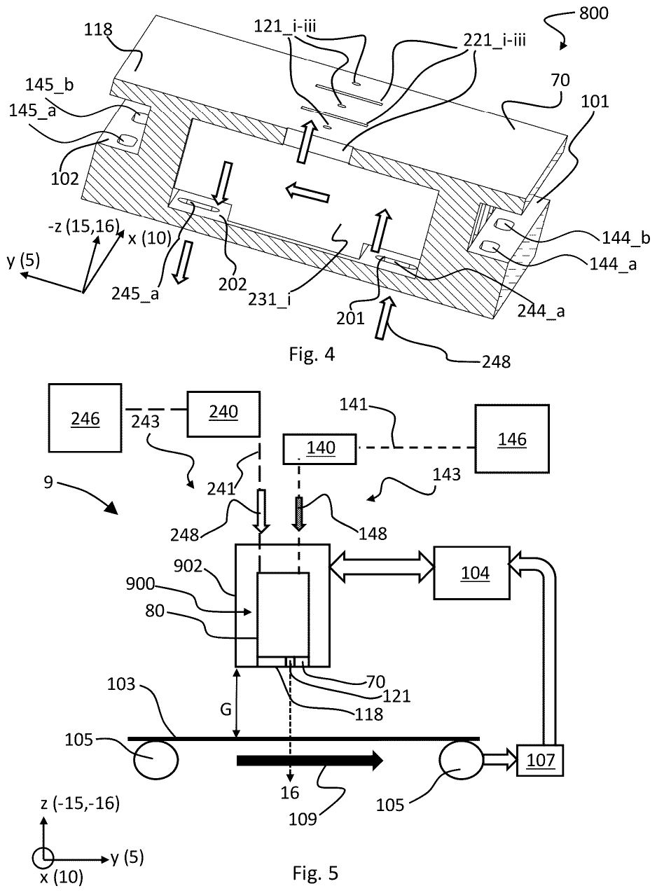

Considering now FIG. 4, this depicts an actuator component 800, similar to that of FIG. 2A-FIF. 2C, the main difference being that there are two gas manifolds 201,202 arranged below (in the liquid chamber height direction 15) and fluidically connected to the plurality of gas channels 231, such that gas can be supplied to the gas channels 231 at one end, in the liquid chamber extension direction 5, from the gas manifold 201 and gas can be removed from the gas channels 231, at the opposite end in the liquid chamber extension direction 5, into the gas manifold 202. The gas manifolds 201,202 may be connected to one or more gas ports 244 and one or more gas ports 245 respectively. There may be 244_a-244_j gas ports connected to the gas manifold 201 and 245_a-245_k gas ports connected to the gas manifold 202, for example (in FIG. 4 gas ports 244_a and 245_a may be seen). In this arrangement the plurality of gas ports 244,245 are arranged below the gas manifolds 201,202 in the liquid chamber height direction 15. They may conveniently be connected to further gas paths within a droplet ejection apparatus 1,2,9.

In other arrangements, the gas ports 244 and gas ports 245 may be located in alternative positions, provided that the fluidic separation of the gas path 243 and the liquid path 143 is maintained. In operation, where the gas supply 240 is operating as a positive gas supply 240, an arrangement such as this may supply gas to the plurality of gas channels 231 and remove it therefrom. For example, in this arrangement the gas ports 244 are operating as inlet gas ports 244 to feed the gas manifold 201, and the gas manifold 201 subsequently supplies gas to the plurality of gas channels 231. A portion of gas may exit the gas channels 231 via the respective gas orifices 221 and the remainder may return to the gas supply 240 via the gas manifold 202 and the gas ports 245, which are operating as outlet gas ports 245 (see the white arrows 248 in FIG. 4). Alternatively, when operating as a negative gas supply 240, gas may enter the gas channels 231 via the gas orifices 221 and then flow to the gas supply 240 via the gas manifolds 201,202 and then via both the gas ports 244 and the gas ports 245 which may be operating as outlets to remove gas from the gas manifolds 201,202 respectively.

It can further be seen, in FIG. 4, that there are a plurality of liquid inlets 144_a,144_b fluidically connected to the liquid manifold 101 and a plurality of liquid outlets 145_a,145_b fluidically connected to the liquid manifold 102. In this arrangement the plurality of liquid inlets 144 and plurality of liquid outlets 145 are arranged below the liquid manifolds 101,102 in the liquid chamber height direction 15. They may conveniently be connected to further liquid paths within a droplet ejection apparatus 1,2,9. It may be understood that, in other arrangements, the liquid inlets 144 and liquid outlets 145 may be located in alternative positions, provided that the fluidic separation of the gas path 243 and the liquid path 143 is maintained. In operation an arrangement such as this may supply liquid from the liquid supply 140 via the liquid path 143 to the plurality of liquid chambers 131, with liquid entering the liquid chambers 131 from the liquid manifold 101, which manifold is fed with liquid via the liquid inlets 144. A portion of liquid may be ejected from the liquid chambers 131 via the nozzles 121 in response to print instructions, and the remainder of the liquid may return to the liquid supply 140 via the liquid manifold 202 and then the liquid outlets 145.

Turning now to FIG. 5, this is a schematic drawing of a droplet ejection apparatus 9 comprising an actuator component 900 according to an embodiment, having an actuator assembly 80 and a nozzle plate 70, arranged in a droplet ejection head 902. The droplet ejection apparatus 9 also comprises a transport mechanism 105 for moving a deposition media 103 and a controller 104. The droplet ejection head 902 is mounted above the deposition media 103 such that there is a gap G between it and the deposition media 103. The deposition media 103 moves in a media movement direction 109. The nozzle plate 70 has a media facing surface 118 in which the exits of the one or more nozzles 121 are located. The actuator component 900 is arranged to eject droplets via the one or more nozzles 121 toward the deposition media 103 in response to signals sent by the controller 104. The controller 104 may also control the transport mechanism 105.

Alternatively, there may be a master controller to control all aspects of the droplet ejection apparatus 9. There may additionally be media encoder circuitry 107. The droplet ejection apparatus 9 further comprises a liquid supply 140, a liquid path 143 comprising inlet liquid path 141, a gas supply 240 and a gas path 243 comprising gas path 241. Although not visible in FIG. 5, the actuator component 900 further comprises one or more gas orifices 221 for flowing a gas through the gas orifice exit in the media facing surface 118. Likewise, the actuator component 900 comprises one or more liquid chambers 131, one or more gas channels 231, etc. as described herein. The droplet ejection head 902 may comprise one or more actuator components 900. It may be generally understood that any of the actuator components 100-1000 described herein may be used in the droplet ejection apparatus 9.

### Method of Operation

A method of operation of any of the apparatus 1,2,9 described herein may comprise ejecting droplets of liquid from the nozzles 121, in accordance with printing instructions and flowing gas through the gas orifices 221, so as to control the droplets of liquid ejected from the droplet ejection nozzles 121. Where the gas supply 240 is a positive gas supply 240, the method may further comprise arranging the gas supply 240 so as to supply gas from the positive gas supply 240 to the actuator component 100-900 via the gas flow path 243 and flowing gas through the gas orifices 221 from inside the actuator component 100-900 to outside the actuator component 100-900. Where the gas supply 240 is a negative gas supply 240 the method may further comprise arranging the gas supply 240 so as to draw gas through the gas orifices 221 into said actuator component 100-900 and via said gas path 243 to said negative gas supply 240. The method may further comprise controlling the droplet composition by means of interaction with the gas flowing through the gas orifices 221. Additionally, or instead, the method may comprise controlling the droplet ejection velocity as a function of the gas velocity flowing through the gas orifices 221. The method may comprise adjusting the gas velocity as it flows through the gas orifices 221 as a function of a droplet ejection velocity. In some applications the gas velocity as it flows through the gas orifices 221 may be greater than a droplet ejection velocity.

The gas supply 240 may be continuous such that the flowing of the gas through the gas orifices 221 is substantially continuous or it may alternatively be pulsed. It may be advantageous, for example, to pulse the supply of gas to facilitate purging of the gas path 243 or cleaning of the nozzle plate 70. The gas supply 240 may be adjustable to operate as a positive or negative gas supply depending on operational requirements.

Where the apparatus 1,2,9 comprises a return liquid path 142, the method may further comprise flowing unejected liquid from the liquid chambers 131 to the liquid supply 140 via the return liquid path 142. The liquid may, for example, flow from the plurality of liquid chambers 131 into a return liquid manifold 102 and from there to the return liquid path 142. Similarly, where the apparatus 1,2,9 comprises a return gas path 242, the method may further comprise flowing gas from the gas channels 231 to the gas supply 240 via the return gas path 242. The liquid may for example flow from the plurality of gas channels 231 into the gas manifold 201 and from there to the return gas path 242.

Alternatively, where there is a second gas manifold 202, the gas may flow from the plurality of gas channels 231 to the return gas manifold 202 and from there to the return gas path 242. It may be generally understood that, depending on the application, the liquid used in the method of printing may be one of many types of suitable liquids, For example it may be a printing ink, it may, for example, be an ink for printing on glass, or on plastic, or on ceramic, or on textiles, or on paper or cardboard.

Alternatively, the liquid may be suitable for more novel applications, such as for printing electrical components, or for use in 3D printing applications to make 3D printed components. Alternatively, the liquid may be suitable for printing onto vehicles, or buildings or other 3D objects. It may further be understood that the method may involve using a gas, where the gas may comprise one or more of the following: atmospheric air, air heated above or cooled below ambient temperatures, humid air, where the humidity is greater than ambient, dehumidified air, where the humidity is less than ambient, inert gases, a solvent used as a component of the liquid, where the solvent is in gaseous form.

### Method of Manufacture

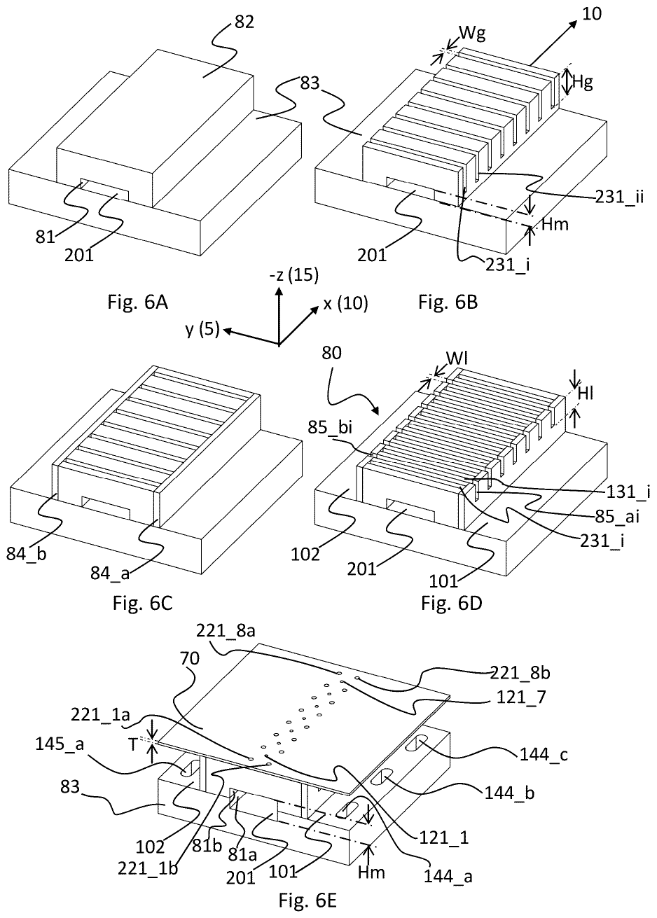

Turning now to FIG. 6A-FIG. 6D, these summarise the main steps in a method of manufacturing an actuator assembly 80 for an actuator component 100-900 for a droplet ejection head, as described herein. The main steps are as follows:

Step 1: forming one or more cut-outs 81 in one or more strips of piezoelectric material 82 and fixedly attaching the strip(s) of piezoelectric material 82 to a substrate 83, as depicted in FIG. 6A, so as to form one or more gas manifolds 201. The strip of piezoelectric material 82 may, for example, comprise lead zirconate titanate (PZT), but any suitable material may be used. This step may further comprise fixedly attaching a larger piece of piezoelectric material to the substrate 83 and then cutting or forming or machining the larger piece so as to form one or more strips of piezoelectric material 82, where one or more cut-outs 81 have been pre-formed in the larger piece of piezoelectric material, so as to provide one or more gas manifolds 201.

Alternatively, the one or more gas manifolds 201 may be formed as one or more cut-outs 81 (not shown) in the substrate 83, prior to attaching the one or more strips of piezoelectric material 82. In another implementation of the method, there may be one or more cut-outs 81a in the substrate 83 and one or more cut-outs 81b in the one or more strips of piezoelectric material 82, such that, when the two parts are joined together, the one or more gas manifolds 201 are formed by aligning the two cut-outs 81a,81b (see FIG. 6E). The cut-outs 81 may be arranged adjacent to, or at the interface or boundary between, the substrate 83 and the respective strip of piezoelectric material 82 in the liquid chamber height direction 15.

Step 2: forming one or more arrays of gas channels 230 in the one or more strips of piezoelectric material 82, as shown in FIG. 6B, so as to create a plurality of open-ended gas channels 231 in said one or more strips of piezoelectric material 82, wherein the gas channels 231 are aligned in an array direction 10 along the one or more strips of piezoelectric material 82.

Each gas channel 231 is formed such that it comprises an open channel in the strip of piezoelectric material 82 with an opening at both ends in the liquid chamber extension direction 5, and such that the gas channels 231 are also open along their extent on the opposite side to the substrate 83, (i.e. in the liquid chamber height direction 15). Further, each gas channel 231 opens into and is fluidically connected to the gas manifold 201 on the side of the piezoelectric strip 82 facing the substrate 83. For example, they may be formed to be deep enough to intersect with the cut-outs 81 forming the gas manifold 201 i.e., they may be partially of fully open on the side facing the substrate 83 so as to be fluidically connected to the gas manifold 201. Any suitable method may be used to form the gas channels 231, such as laser cutting, or cutting with a dicing blade or saw, or using a water jet cutter, or any other suitable cutting tool. As an example, dicing blades may be used that are between 3 μm and 160 μm wide. Depending on the required design, the gas channels 231 may be formed with any suitable width, Wg; for example, they may be between 3 μm and 160 μm wide, more preferably between 50 μm and 100 μm wide. The gas channels 231 may be narrower than the liquid chambers 131 in the array direction 10 (Wg<Wl).

This step may also comprise forming the liquid chambers 131 such that each liquid chamber 131 may comprise an open channel in the strip of piezoelectric material 82 with an opening at both ends in the liquid chamber extension direction 5 and such that the liquid chambers 131 may also be open along their extent on the opposite side to the substrate 83 (i.e. in the liquid chamber height direction 15). Any suitable method may be used to form the liquid chambers 131, such as laser cutting, or cutting with a dicing blade or saw, or using a water jet cutter, or any other suitable cutting tool. Depending on the required design, the liquid chambers 131 may be formed with any suitable width, Wl; for example, they may be between 3 μm and 160 μm wide, more preferably between 50 μm and 100 μm wide. The liquid chambers 131 may be formed such that they are less tall than the gas channels 231 so as not to impinge on the gas manifolds 201,202. Preferably the same method may be used to form both the gas channels 231 and the liquid chambers 131. Where the two are the same width (Wl=Wg) the same dicing blade may be used to form both the gas channels 231 and the liquid chambers 131. Alternatively, the liquid chambers 131 may be formed later (see step 4 below).

The open design of the strip of piezoelectric material 82 mounted on the substrate 83 may allow a dicing blade, for example, to enter from the side and traverse the entire length of the liquid chambers 131, in the liquid chamber extension direction 5, from one end to the other to form said open channel, i.e. the liquid chambers may have a constant height Hl (and cross-sectional area) along their entire length in the liquid chamber extension direction 5. This may lead to more uniform flow along the liquid chambers 131. This is unlike other designs where, for example, the dicing blade must be lowered from above to cut the liquid chambers 131, leading to channels that are less tall at their ends in the liquid chamber extension direction 5. Such unlike designs consequently have changes to the liquid flow velocities at the ends of the liquid chambers 131 as the depth varies. The gas channels 231 may be formed similarly to the liquid chambers 131 such that they too have a constant height Hg (and cross-sectional area) along their entire length in the liquid chamber extension direction 5.

Step 3: forming one or more cover parts 84_a,84_b that are conformal to at least some of said one or more strips of piezoelectric material 82 and at least some of said substrate 83. The method may comprise fixedly attaching a first cover part 84_a to each of said one or more strips of piezoelectric material 82 at a first end in said liquid chamber extension direction 5 and fixedly attaching a second cover part 84_b to each of said one or more strips of piezoelectric material 82 at a second opposite end in the liquid chamber extension direction 5. Step 3 may further comprise fixedly attaching the one or more cover parts 84_a,84_b to at least some of said substrate 83, as shown in FIG. 6C. The cover parts 84_a,84_b may comprise a single layer of material, or be formed from a number of layers of material fixedly attached together. Alternatively, they may comprise a number of parts that have been pre-shaped to be conformal to a particular part of the strips of piezoelectric material 82 or the substrate 83 that are then fixedly attached together.

The cover part 84_a,84_b may be shaped by machining or moulding or any suitable manufacturing technique, such as cutting or grinding or laser ablating. The material of the cover part 84_a,84__b may be the same material as the strips of piezoelectric material, or a different material. The material of the cover part 84_a,84_b may comprise a material that is acoustically the same or similar to the strips of piezoelectric material 82 and/or the substrate 83. The cover part 84_a,84_b may be fixedly attached using any suitable method, for example, the attachment method may comprise bonding, using any suitable bonding material. The bonding method may comprise depositing or 3D printing a bonding material in appropriate locations. The bonding material may be curable, e.g., a thermally curable material, or, if the cover part 84_a,84_b is formed from a UV transparent material, a UV curable material may be used. Epoxy resins—bonding materials that are curable in a temperature range that does not damage or otherwise compromise the PZT performance—may be used; they may, for example, be curable below 140° C., more preferably below 120° C. Depending on the design of actuator component being made, whether with or without flow recirculation, whether an end shooter or a side shooter actuator, there may be cover parts on one side or both sides of the strips of piezoelectric material in the liquid chamber extension direction 5.

Where there is one cover part 84_a (as in the embodiment of FIG. 1A-FIG. 1B) the method may comprise fixedly attaching a first cover part 84_a to each of said one or more strips of piezoelectric material 82 at a first end in the liquid chamber extension direction 5. Where there are two cover parts 84_a,84_b (as in the embodiment of FIG. 2A-FIG. 2C, FIG. 4 and as shown in FIG. 6C-FIG. 6E) the method may further comprise fixedly attaching a second cover part 84_b to each of said one or more strips of piezoelectric material 82 at a second opposite end in the liquid chamber extension direction 5.

Step 4—Once the cover part(s) 84_a,84_b are attached, apertures 85_a,85_b may be formed in the cover parts 84_a,84_b. The method of manufacture may therefore comprise forming a plurality of apertures 85_a,85_b in the first and second cover parts 84_a,84_b such that the first and second cover parts 84_a,84_b comprise at least one aperture 85_a,85_b per liquid chamber 131 over a substantial portion of the array of liquid chambers 130. The respective apertures 85_a,85_b per liquid chamber 131 are paired such that for each liquid chamber 131 there is a continuous liquid path that passes through the first aperture 85_a in the first cover part 84_a at the first end of the liquid chamber 131, through the liquid chamber 131 and through the aperture 85_b in the second cover part 84_b at the second end of the liquid chamber 131. As described above, with respect to forming the liquid chambers, the apertures 85_a,85_b may be formed using a cutting blade that enters from the side and traverses the entire length of each aperture so as to form each aperture 85_a,85_b with a constant height Ha, this height may be the same as that of the adjacent liquid chamber 131 (Ha=Hl) or it may be less (Ha>Hl), to allow a restrictor at the entrance and/or exit to the liquid chamber in the liquid chamber extension direction 5.

Forming the apertures 85_a,85_b may comprise running a dicing blade through the cover parts 84_a,84_b at appropriate positions in the array direction 10. If the liquid chambers were not formed as part of step 2 (see above) then this step may also comprise forming the liquid chambers 131, in which case this step may be performed by running a dicing blade through the one or more cover parts 84_a,84_b and the strip of piezoelectric material 82 in a single pass per liquid chamber 131 so as to form the continuous liquid path therethrough. The liquid chambers 131 and the apertures 85_a,85_b may be formed such that they are continuous through the cover part 84_a,84_b and the strips of piezoelectric material 82. The liquid chambers 131 and the apertures 85_a,85_b may be formed such that they are less tall than the gas channels 231 so that they do not impinge on the gas manifold 201,202. The liquid chambers 131 are also open along their extent on the opposite side to the substrate 83, in the liquid chamber height direction 15, as are the apertures 85_a,85_b.

To form the gas channels 231 and/or the liquid chambers 131 a dicing blade may be lowered towards the substrate 83 to one side of the strip of piezoelectric material 82 and then moved across the strip of piezoelectric material 82, in the liquid chamber extension direction 5. Where there is more than one strip of piezoelectric material 82, the dicing blade may be moved so as to form all of the liquid chambers 131 and/or the gas channels 231 at a given position in the array direction 10 at the same time. The dicing blade may then be lifted and returned to its original position, and the actuator assembly 80 may be incrementally moved in the array direction 10 so that the next row of liquid chambers 131 and/or the gas channels 231 may be formed. When forming the liquid chambers 131, the dicing blade may be lowered to a lesser extent than when forming the gas channels 231 such that the liquid chamber height Hl is less than the gas channel height Hg (Hl<Hg). Depending on how and where the gas manifold 201 was formed, the liquid chamber height Hl may also be less than the gas channel height Hg minus the gas manifold height Hm (i.e., Hl<(Hg−Hm)).

Alternative methods of forming the gas channels 231 and liquid chambers 131 may be envisioned. For example, both liquid chamber and gas channel arrays 130,230 may be formed at the same time using a dicing blade to cut the open channels (slots) in the one or more strips of piezoelectric material 82 as described above in Step 2. For example, the dicing blade may be used to cut alternate deeper slots for the gas channels 231 and shallower slots for the liquid chambers 131, by altering the depth settings appropriately as the blade is moved incrementally along the strip of piezoelectric material 82, in the array direction 10. The one or more cover parts 84_a,84_b may then be attached and then the liquid chamber apertures 85_a,85_b, through the cover parts 84_a,84_b, may be formed in a second cutting operation. Alternatively, the liquid chamber apertures 85_a,85_b may be formed prior to attaching the cover parts 84_a,84_b to the strip of piezoelectric material 82. Alternatively, the liquid chamber apertures 85_a,85_b may be formed at the same time as the liquid chambers 131 in a single operation, for example using the same dicing blade to cut through both the one or more cover parts 84_a,84_b and the one or more strips of piezoelectric material 82.

In general, the method of manufacture comprises selectively forming a plurality of apertures 85_a in the first cover parts 84_a, wherein said first cover parts 84_a comprise at least one aperture 85_a per liquid chamber 131 over a substantial portion of the array of liquid chambers 130 and, where present, selectively forming a plurality of apertures 85_b in said second cover parts 84_b wherein said second cover parts 84_b comprise at least one aperture 85_b per liquid chamber 131 over a substantial portion of the array of liquid chambers 130. It may be understood that where the embodiment comprises two cover parts 84_a,84_b per strip of piezoelectric material 82, the apertures 85_a,85_b may be aligned, e.g. at the first end and second end of each respective liquid chamber 131 such that liquid can flow therethrough, entering at the first end and exiting at the second end.

Instead of cutting slots to form the apertures 85_a,85_b, alternatively they may be formed using a different method, such as laser etching or drilling, or boring. The apertures 85_a,85_b may not extend the full height of the liquid chambers 131. The apertures 85_a,85_b may be one or more holes or orifices in the one or more cover parts 84_a,84_b connecting the liquid manifold 101 to the first end of the liquid chambers 131 and, where present, connecting the liquid manifold 102 to the second end of the liquid chambers 131. Where the gas channels 231 are longer than the liquid chambers 131, the above-described method steps may be altered appropriately, so that gas channel apertures are cut through the cover part 84_a,84_b.

Step 5—Once the actuator assembly 80 has been formed as required, with any additional steps and stages incorporated that may be necessary (such as forming electrical traces and connections, or adding protective layers for chemical/electrical isolation of parts, or adding additional parts to complete the formation of the liquid manifold(s) 101,102), then the nozzle plate 70 may be attached to the actuator assembly 80 to form the actuator component 100-900. The gas orifices 221 and/or the nozzles 121 may be formed prior to the attachment stage and/or after the nozzle plate 70 is in situ, as required. The gas orifices 221 and/or the nozzles 121 may be formed using any suitable method, such as laser ablation or etching.

It may be generally understood that the electrical traces, drive electrodes and connections may be deposited as continuous layers, built up one at a time, over some or all of the external surfaces of the actuator component 100-900, such as on the substrate 83 and the strip(s) of piezoelectric material 82, using any suitable method; such as electroless plating or metal sputtering/evaporation. Cutting or other removal techniques may then be used to remove some of the metal layer or layers so as to form electrically isolated electrical traces, drive electrodes, and connections. If the electrical traces, drive electrodes, and connections are formed using electroless plating, initially the gas channels 231 may be formed using a shallow cut that does not connect them to the gas manifold 201. The gas channels 231 and the liquid chambers 131 may then be metalised, then another cut may be used to connect the gas channels 231 to the gas manifold(s) 201,202. These steps would prevent metalisation of the gas manifold(s) 201,202, which could cause electrical shorts.

An alternative method would be to use line of sight plating of metal, which is a method that allows control of where and how deep into the gas channels 231 any metal may be deposited. Still further, the gas manifold(s) 201,202 could have a dissolvable/removable block formed inside it, the gas channels could be cut as normal, connecting to the gas manifold(s) 201,202, and the block. Metalisation would then be performed, and the block subsequently dissolved/removed, along with any metal deposited on the block, enabling connection between the gas channels 231 and the now open gas manifold(s) 201,202.

If the actuator component is for an end shooter, as in FIG. 1A-FIG. 1B, the nozzle plate 70 may be fixedly attached to the strip of piezoelectric material 82 at the second end in the liquid chamber extension direction 5, opposite to the cover part 84_a, such that said nozzle plate 70 acts to fluidically seal the gas channels 231 and the liquid chambers 131 in the liquid chamber extension direction 5.

If the actuator component is for a side shooter, such as that of FIG. 2A-2C, the nozzle plate 70 may be fixedly attached to the strip of piezoelectric material 82 at one side in the liquid chamber height direction 15 (i.e. on the opposite side to the substrate 83) such that the nozzle plate 70 acts to fluidically seal the liquid chambers 131 and the gas channels 231, in the liquid chamber height direction 15, as shown in FIG. 6E. It can further be seen that, in the arrangement of FIG. 6E, the nozzle plate 70 may further seal the apertures 85_a,85_b in the cover parts 84_a,84_b connecting the liquid manifolds 101,102 to the liquid chambers 131. The nozzle plate 70 may also seal the liquid manifolds 101,102 in the liquid chamber height direction 15, though this is not necessary and other arrangements may be used to form and/or seal the liquid manifolds 101,102. It may be understood that the actuator component 100-900 may comprise further parts, for example, so as to seal the liquid manifolds 101,102 at either side in the liquid chamber extension direction 5 and at either end in the array direction 10.

Still further, it may be understood that in other arrangements, such as the end shooter actuator component of FIG. 1A-FIG. 1B, the nozzle plate 70 may be attached to the strip of piezoelectric material 82 at one side in the liquid chamber extension direction 5 so as to fluidically seal the liquid chambers 131 and the gas channels 231 at a second end of the liquid chambers 131 in the liquid chamber extension direction 5. It may be understood that, in such a design, a cover part 84_a may be arranged on the opposite side of the strip of piezoelectric material 82 to the nozzle plate 70 in the liquid chamber extension direction 5, i.e., at the first end of the liquid chambers 131. Apertures 85_a may be formed in the cover part 84_a to connect to the plurality of liquid chambers 131 and fluidically connect them to the liquid manifold 101. For example, the method of manufacture may comprise fixedly attaching a first cover part 84_a to each of said one or more strips of piezoelectric material 82 at a first end in the liquid chamber extension direction 5 and selectively forming a plurality of apertures 85_a in said first cover parts 84_a such that the first cover parts 84_a comprise at least one aperture 85_a per liquid chamber 131 over a substantial portion of the array of liquid chambers 130.

It may further be understood that where the actuator component does not comprise a return liquid path 142 or a second (return) liquid manifold 102 (i.e. it is not a recirculation actuator component for the liquid path 143) then only a first cover part 84_a with apertures 85_a at the first end of the liquid chambers 131 may be required, and that the above-described steps may be adjusted accordingly.

It may further be understood that an end shooter actuator component may further require a top part 86 (see FIG. 1A) that may be attached on the opposite side of the strip of piezoelectric material to the substrate 83 and the one or more gas manifolds 201,202 so as to fluidically seal the gas channels 231 and the liquid chambers 131 in the liquid chamber height direction 15. The top part 86 may be attached before or after the nozzle plate 70.

It may be understood that, depending on the type of actuator component being made, the order of the above-described steps may be altered as required, and additional steps inserted as necessary to form other features of the actuator component and the droplet ejection head, for example, forming electrical traces and connections or providing insulating and protective coatings. It may be generally understood that the above methods of manufacture may be used, with appropriate adjustments, whether there is one cover part 84_a per respective strip of piezoelectric material 82 (i.e. for an end shooter actuator component) or two cover parts 84_a,84_b per respective strip of piezoelectric material (i.e. for a side shooter actuator component).

In general, the method of manufacture may comprise forming one or more cut-outs 81 in either the substrate 83 and/or the strip of piezoelectric material 82;
fixedly attaching the one or more strips of piezoelectric material 82 to the substrate 83 such that each of said one or more cut-outs 81 is arranged adjacent to the interface between the substrate 83 and a respective strip of piezoelectric material 82 so as to form one or more gas manifolds 201,202, wherein each of the one or more arrays 130 of liquid chambers 131 are fluidically separated from the one or more gas manifolds 201,202; and
wherein each of said one or more arrays 230 of gas channels 231 are fluidically connected to at least one of said one or more gas manifolds 201,202.

### General Considerations

It may be generally understood that the actuator components 100-900 for a droplet ejection head described herein comprise an actuator assembly 80 and a nozzle plate 70. It may be understood that the actuator components may comprise further components, as required.

The actuator assembly 80 may comprise a plurality of liquid chambers 131, arranged in a liquid chamber array 130, extending in an array direction 10, where the plurality of liquid chambers 131 are arranged to be fluidically connectable to a liquid supply 140. The actuator assembly 80 may further comprise a plurality of gas channels 231, arranged in a gas channel array 230, also extending in the array direction 10, where the plurality of gas channels 231 are arranged to be fluidically connectable to a gas supply 240. The liquid chamber array 130 and the gas channel array 230 are arranged to be fluidically independent from each other.

The nozzle plate 70 may comprise a plurality of droplet ejection nozzles 121, arranged in a nozzle array 120, extending in the array direction 10, and a plurality of gas orifices 221, arranged in an orifice array 220, extending in the array direction 10. The gas orifices 221 and the droplet ejection nozzles 121 may be arranged in a repeating pattern extending in the array direction 10.

Each liquid chamber 131 may be arranged to be fluidically connected to one or more of said droplet ejection nozzles 121 and actuable for ejection of droplets of a liquid. The plurality of gas channels 231 may be arranged to be fluidically connected to a respective one or more gas orifices 221 for flow of a gas. In use, the actuator component 100-900 may be configured such that gas flowing through the gas orifices 221 controls one or more properties of the liquid ejected from the droplet ejection nozzles 121.

The actuator assembly 80 may comprise a substrate 83 and one or more strips of piezoelectric material 82, fixedly attached to the substrate 83. Each strip of piezoelectric material 82 may have one or more cut-outs 81, arranged at the boundary between it and the substrate 83, where each cut-out 81 may be formed entirely in the substrate 83, entirely in the strip of piezoelectric material 82 or as aligned cut-outs 81a,81b in the substrate 83 and the strip of piezoelectric material 82, respectively. The cut-outs 81 may form the gas manifolds 201,202 and may be fluidically connected to the plurality of gas channels 231 whilst remaining fluidically isolated from the plurality of liquid chambers 131.

In some arrangements, the gas orifice array 220 may start before and finish after the nozzle array 120 in the array direction 10, such that there is a gas orifice 221 outermost in the positive and negative array direction 10. In such an arrangement, the total number of gas orifices 221 would be one more than the number of nozzles 121, e.g., m=n+1. Further, it may be understood that the piezoelectric strip 82 may comprise buffer regions in the array direction 10. A buffer region may comprise dummy liquid chambers and dummy gas channels that have no nozzles or orifices respectively. Dummy liquid chambers and dummy gas channels may not eject ink through nozzles 121, or allow gas flow through orifices 221, but, in use, allow fluid (liquid or gas respectively) to travel therethrough. Buffer regions comprising these may, for example, be found at the outer ends of the actuator component 100-900 in the array direction 10. As such, they may improve the flow uniformity along the actuator component 100-900 in the array direction 10 and may also aid in improving the stress profile along the actuator component 100-900 in the array direction 10. They may, therefore, improve the droplet ejection performance and print quality (as stress in actuator components, such as those described herein, can lead to flow non-uniformity that ‘prints through’ into observable defects in the printed image or product). Buffer regions may also be used to create gaps between nozzle clusters for control of, for example, the woodgrain effect. In some instances, buffer regions may comprise regions without liquid chambers 131 or gas channels 231.

In some of the embodiments described herein, the exits of the nozzles 121 and of the gas orifices 221, in the media-facing surface 118, are circular in cross-section, but it may be understood that this is by no means limiting and, in other arrangements, the nozzles 121 and/or the gas orifices 221 may have other shapes at their exits. The gas orifices 221 may have any suitable shape, for example, rectangular, circular, oval, or more complex geometric shapes. The gas orifices 221, as described herein with reference to any of the embodiments and arrangements disclosed, may have the same or a different cross-sectional shape to the nozzles 121. Further, the exits of the gas orifices 221 may be larger or smaller in cross-sectional area than those of the nozzles 121, and it may be understood that the cross-sectional areas of the gas orifices 221 and nozzles 121 may be chosen depending on operational requirements.

The cross-sectional shape and area of the nozzles 121 and/or the gas orifices 221 may be the same through the nozzle plate 70, e.g., through the nozzle plate thickness T in the ejection direction 16, or they may vary (for example there may be a tapered hole such that the cross-sectional area increases (or alternatively decreases) through the nozzle plate 70 from inlet to exit, e.g., through the nozzle plate thickness T. Further, the gas orifices 221 and/or the nozzles 121 may be angled such that they pass through the nozzle plate 70 at an angle to the nozzle plate thickness T. For example, the gas orifices 221 may be angled so as to direct the gas flow through the gas orifices 221 towards the nozzles 121. Where there are a plurality of gas orifices 221 surrounding a nozzle 121, such angled gas orifices 221 may improve the control of the droplet trajectory.

With respect to the gas orifices 221, where the direction of the gas flow depends on the operation of or type of gas supply 240, it may be generally understood that the terms ‘inlet’ and ‘exit’ of the gas orifices 221 refer to the gas orifice openings internal to the actuator component 100-900 and external to the actuator component 100-900 respectively (e.g., the ‘exit’ is in the media-facing surface 118). The minimum diameter or width of any holes in the nozzle plate 70, whether gas orifices 221 or nozzles 121, depends in part on the material of the nozzle plate 70 and the manufacturing methods available. For example, a minimum of 18 μm is likely achievable with laser drilling, whilst, for a silicon nozzle plate, Deep Reactive Ion Etching (DRIE) may be used so that the holes may be smaller, for example as little as 10 μm.

It may be understood that, in arrangements where the nozzles 121, in a given array 120, are staggered, such that one or more adjacent nozzles 121, in the array direction 10, are offset from each other in the liquid chamber extension direction 5 (see for example FIG. 3D, FIG. 3E and FIG. 6E), then the nozzle spacing ns may be measured by projecting the centre-lines of the nozzles 121 onto a common line, parallel to the array direction 10. Similar may be done where the gas orifices 221 are, likewise, staggered in the liquid chamber extension direction 5 (see for example FIG. 3C, FIG. 3D).

It may be generally understood that a droplet ejection head may comprise one or more actuator components 100-900 as described herein. Further, it may be generally understood that, where the actuator component 100-900 is mounted in a droplet ejection head, or in an apparatus 1,2,9 comprising a plurality of actuator components 100-900 and/or a plurality of droplet ejection heads wherein said droplet ejection heads comprise one or more actuator components 100-900 as described herein, the liquid path 143 and the gas path 243 may be different to those described herein. The paths may be more complex, and may comprise further external sections to connect the fluid supplies 140,240 to the plurality of actuator components 100-900 and/or to the plurality of droplet ejection heads. Further, there may be additional components to the fluid paths, within the one or more droplet ejection heads, to connect the fluid supplies (gas and liquid) to the one or more actuator components 100-900, located within the droplet ejection heads. There may also be additional components, to the fluid paths, to remove fluids (liquid and/or gas) from the actuator components 100-900. Still further, it may be understood that the fluid path layouts 143,243 may be different to those described herein, whilst still performing the essential tasks of supplying the fluids to the gas channels 231 and liquid chambers 131. It may further be generally understood that whatever further components they may comprise, or different layouts they may have, the liquid path 143 and the gas path 243 are fluidically separated from each other throughout.

It may be generally understood that the liquid may be a liquid suitable for ejection as a droplet, i.e., a liquid for droplet ejection; such as a printing ink. It may be understood that printing inks vary greatly in their composition. This can depend on the colour being printed, the pigment if any in the printing ink, the desired properties on the print media (for example opacity, distribution, absorption, light reflection, etc.), and the type of media being printed onto, for example: paper, card, glass, cloth or fibre, metal, ceramic, etc. Additionally, the liquid may be a functional fluid suitable for building up texture or for printing electronics components such as circuit boards, or for building three-dimensional objects (i.e. for 3D printing).

In addition to or instead of the above-described control of the droplet trajectories, the gas path 243 and the gas orifices 221 may generally be used to control other properties of the ejected droplets or of the environment around the droplets. For example, the gas may be used to control humidity/drying rates of droplets by using a gas that is more or less humid than the ambient environment around the droplet ejection apparatus 1,2,9. Similarly, a heated or cooled gas may be used to alter the environment in close proximity to the droplets. Alternatively, for example, the gas may be used to form a controlled environment to aid/prevent reactions in the droplets, for example by using an inert gas, or a gas that comprises one or more components of the liquid. For example, a particular solvent may be used as part of a printing ink, and the same solvent, in gaseous form, may be ejected through the gas orifices to alter, e.g., slow, the evaporation rate of the solvent from the droplets. Passing an inert gas through the gas orifices may be used to reduce oxygen levels in the vicinity of the droplets, delaying or prohibiting any oxygen-based curing that occurs to the droplet in flight. Further, ejecting a gas may simply be used to help keep contamination from the environment (e.g., dust) away from the nozzle plate 70. This may be advantageous when, for example, printing in some industrial environments where there are lots of particulates in the air.

The actuator components 100-900 for a droplet ejection head described herein may comprise liquid chambers 131 with an actuator associated with each liquid chamber 131 and actuable so as to eject droplets via the one or more droplet ejection nozzles 121 associated with the respective liquid chamber 131. For example, one or more of the walls of said liquid chambers 131 may be actuable so as to eject liquid droplets via said one or more droplet ejection nozzles 121. For example, one or more side walls of each liquid chamber 131 may comprise PZT and a suitable drive electrode arrangement, or the liquid chambers 131 may comprise a roof mode actuator arrangement. However, it may be understood that other forms of actuators may also be used, provided that they are suitable to cause the ejection of liquid, via the respective nozzles 121, from an individual liquid chamber 131, in response to print instructions.

It may be generally understood that the liquid supply 140 and the gas supply 240 may comprise a source of liquid and gas respectively, such as an internal liquid reservoir and a gas compressor respectively, or they may be connected to reservoirs 146,246 respectively. Additionally, the liquid supply 140 and the gas supply 240 may comprise pumps, scrubbers, and any other components required to supply the liquid and gas.

It may be understood that whilst the actuator components 100-1000 described herein comprise an actuator assembly 80 formed from a substrate 83 and a strip of piezoelectric material 82, this is by no means limiting, and actuator assemblies 80 may comprise, for example, one or more substrates 83 and a plurality of strips of piezoelectric material 82, each strip of piezoelectric material 82 comprising one or more arrays of liquid chambers 130 and one or more arrays of gas channels 230. Where appropriate, adjacent strips of piezoelectric material 82 may share liquid manifolds 101 or 102. For example, two strips of piezoelectric material 82 arranged on a substrate 83 may share a liquid manifold 101 arranged between them in the liquid chamber extension direction. Where the actuator component is a recirculation head, the strips of piezoelectric material 82 may further comprise a respective liquid manifold 102 on their outer edges in the liquid chamber extension direction 5. Other arrangements of manifolds for two or more strips of piezoelectric material 82 may be envisioned. It may further be understood that the embodiments described herein may be combined in any suitable manner, and more generally, that when any of the actuator components 100-900 described herein are incorporated into a droplet ejection head, said head may comprise additional parts, not shown, such as liquid connections, printhead electronics, external electrical connections, etc.

It may further be understood that in some arrangements the gas channels 231 may not be connected to a respective one or more gas orifices 221 and instead may be provided with a flow of gas through the gas channels 231 for thermal control purposes. Still further, a thermal control fluid may flow through the gas channels 231, which may then generally be referred to as thermal control fluid channels 231T, where the thermal control fluid may be a gas or a liquid. As such the arrangement may comprise an actuator component as described herein and/or an apparatus comprising an actuator component as described herein. A method of operating such an actuator component and/or apparatus may comprise controlling the thermal characteristics of the thermal control fluid and hence of the ejected droplets of liquid from the nozzles 121. Such control may comprise cooling or heating the thermal control fluid, for example before it enters the actuator component, depending on the operating conditions and desired properties of the liquid for ejection. As such the actuator component and/or the liquid path 143 and/or the thermal control fluid path 243T may comprise one or more temperature sensors linked to one or more controllers. Cooling may comprise thermal energy transfer from the liquid in the liquid chambers 131 to the thermal control fluid in the thermal control fluid channels 231T, whilst for heating the liquid for ejection the thermal energy transfer would be from the thermal control fluid in the thermal control fluid channels 231T to the liquid in the liquid chambers 131. Whether heating or cooling, it may generally be understood that the transfer of thermal energy may be via conduction through the structure of the actuator component, in particular, via the shared walls 132 separating the liquid chambers 131 from the thermal control fluid channels 231T. It may be understood that control of the temperature of the liquid may control other properties of the liquid such as the viscosity. It may be understood that the method of constructing the actuator component for such an arrangement may be similar to that described above, with the step of forming gas orifices 221 in the nozzle plate 70 being omitted.

In general terms, an actuator component for a droplet ejection head for thermal control may comprise:
an actuator assembly and a nozzle plate; wherein the actuator assembly comprises a plurality of liquid chambers arranged in a liquid chamber array extending in an array direction; and a plurality of thermal control fluid channels arranged in a thermal control fluid channel array extending in the array direction; wherein the plurality of liquid chambers and the plurality of thermal control fluid channels are fluidically independent;
wherein the plurality of liquid chambers are arranged to be fluidically connectable to a liquid supply;
wherein the plurality of thermal control fluid channels are arranged to be fluidically connectable to a thermal control fluid supply;
wherein the nozzle plate comprises a plurality of droplet ejection nozzles arranged in a nozzle array extending in the array direction;
wherein each liquid chamber is arranged to be fluidically connected to one or more of the droplet ejection nozzles and actuable for ejection of droplets of a liquid;
wherein the plurality of thermal control fluid channels and the plurality of liquid chambers are arranged in a repeating pattern extending in the array direction; and
wherein the actuator component is configured such that in use thermal control fluid flowing through the thermal control fluid channels controls the thermal properties of the liquid flowing through the liquid chambers to thereby control the thermal properties of the liquid ejected from the droplet ejection nozzles.

A droplet ejection head may comprise one or more actuator components for thermal control. A droplet ejection apparatus may comprise one or more actuator components for thermal control or one or more droplet ejection heads comprising one or more actuator components for thermal control; the droplet ejection apparatus may further comprise a liquid supply and a liquid path and a thermal control fluid path. The droplet ejection apparatus may further comprise a thermal control fluid supply.

The method of operating such a droplet ejection apparatus may comprise ejecting droplets of liquid from one or more of the droplet ejection nozzles in accordance with printing instructions; and
flowing thermal control fluid through the thermal control fluid channels so as to control by thermal transfer the thermal properties of the liquid flowing through the liquid chambers and thereby to control the thermal properties of the liquid ejected from the droplet ejection nozzles.

A method of manufacturing an actuator component for thermal control may comprise the steps of:
forming an actuator assembly, comprising:
forming one or more arrays of liquid chambers in one or more strips of piezoelectric material extending in an array direction, wherein each of the liquid chambers forms an open channel in the strip of piezoelectric material being open in a liquid chamber height direction and open at a first end and a second end in a liquid chamber extension direction;
forming one or more arrays of thermal control fluid channels in the one or more strips of piezoelectric material extending in the array direction, wherein each of the thermal control fluid channels forms an open channel in the strip of piezoelectric material being open in the liquid chamber height direction and open at a first end and a second end in the liquid chamber extension direction; wherein the liquid chamber array and the thermal control fluid channel array are fluidically independent from each other; and
fixedly attaching a nozzle plate to the actuator assembly;
forming droplet ejection nozzles in the nozzle plate either before or after the step of fixedly attaching the nozzle plate to the actuator assembly such that when assembled the actuator component comprises droplet ejection nozzles fluidically connected to the liquid chambers.

A thermal control actuator component for a droplet ejection head may comprise an actuator assembly and a nozzle plate;
wherein the actuator assembly comprises a plurality of liquid chambers arranged in a liquid chamber array extending in an array direction; wherein the plurality of liquid chambers are arranged to be fluidically connectable to a liquid supply;
wherein the nozzle plate comprises a plurality of droplet ejection nozzles arranged in a nozzle array extending in the array direction;
wherein each liquid chamber is arranged to be fluidically connected to one or more of the droplet ejection nozzles and actuable for ejection of droplets of a liquid; wherein the actuator assembly further comprises two or more liquid manifolds arranged below the liquid chambers in a liquid chamber height direction;
wherein a first of the liquid manifolds is fluidically connected to one end of a plurality of liquid chambers in a liquid chamber extension direction; wherein a second one of said two or more liquid manifolds is fluidically connected to a second opposite end of the plurality of liquid chambers in the liquid chamber extension direction; and arranged such that in use liquid flows from the first liquid manifold along the plurality of liquid chambers from the first end to the second end and into the second manifold.

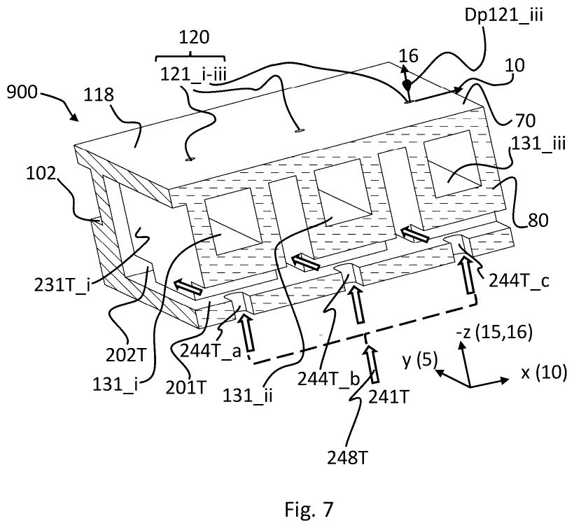

Considering FIG. 7, this is a schematic drawing of a section of an actuator component 900, similar to the section of FIG. 2C, according to another embodiment. The embodiment is similar to that of FIG. 2A-FIG. 2C but comprises two thermal control fluid manifolds 201T,202T. The thermal control fluid manifolds 201T,202T are located below the liquid chambers 131 in the z-direction, or the negative liquid chamber (and thermal control fluid channel) height direction 15. The thermal control fluid manifolds 201T,202T are also located at the base of the thermal control fluid channels 231T, in the liquid chamber height direction 15, so that they intersect with and are fluidically connected to them.

The actuator component 900, therefore, comprises two (or more) thermal control fluid manifolds (201T,202T) arranged such that a first of said thermal control fluid manifolds 201T is fluidically connected to a first end of a plurality of thermal control fluid channels 231T and such that a second one of said two or more thermal control fluid manifolds 202T is fluidically connected to a second opposite end of the plurality of thermal control fluid channels 231T such that in use thermal control fluid flows from said first thermal control fluid control manifold 201T, along the plurality of thermal control fluid channels 231T from said first end to said second end and into said second thermal control fluid manifold 202T.

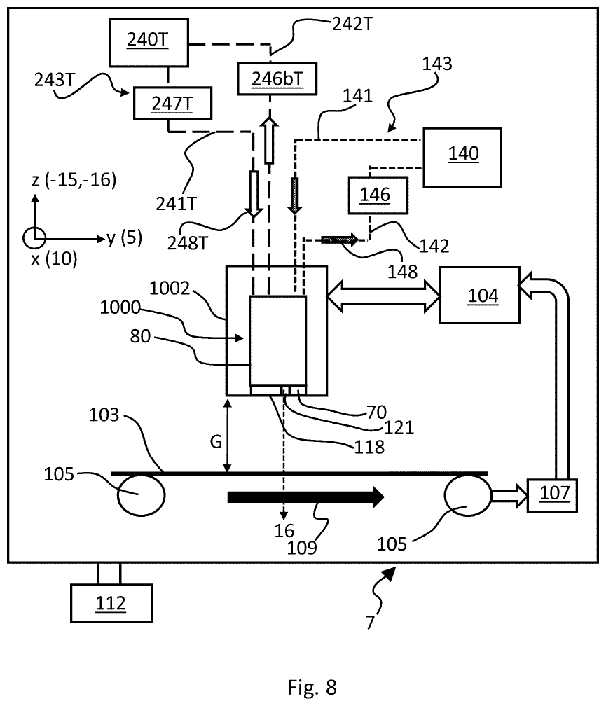

The thermal control fluid channels 231T are fluidically connectable via the thermal control fluid manifold 201T to a thermal control fluid supply 240 (see FIG. 8, for example). It can be seen from FIG. 7 that there are a plurality of thermal control fluid ports 244T_a-244T_c to connect the thermal control fluid path 243T to the thermal control fluid manifold 201T of the actuator component 900. In operation, this enables supply of thermal control fluid from the thermal control fluid supply 240T to the thermal control fluid manifold 201T via the inlet thermal control fluid path 241T, as indicated by the white arrows 248T. The thermal control fluid channels 231T are fluidically connectable via the thermal control fluid manifold 202T to a return thermal control fluid path 242T. The second thermal control fluid manifold 202T may comprise one or more thermal control fluid ports 245T (not shown in this view) to fluidically connect the thermal control fluid manifold 202T to the return thermal control fluid path 242T.

Turning now to FIG. 8, this is a schematic drawing of a droplet ejection apparatus 7 comprising an actuator component 1000 according to an embodiment, having an actuator assembly 80 and a nozzle plate 70, arranged in a droplet ejection head 1002. The droplet ejection apparatus 7 also comprises a transport mechanism 105, for moving a deposition media 103, and a controller 104. The droplet ejection head 1002 is mounted above the deposition media 103 such that there is a gap G between it and the deposition media 103. The deposition media 103 moves in a media movement direction 109. The nozzle plate 70 has a media facing surface 118 in which the exits of the one or more nozzles 121 are located.

The actuator component 1000 is arranged to eject droplets, via the one or more nozzles 121, toward the deposition media 103 in response to signals sent by the controller 104. The controller 104 may also control the transport mechanism 105. Alternatively, there may be a master controller 112 to control all aspects of the droplet ejection apparatus 7. There may additionally be media encoder circuitry 107. The droplet ejection apparatus 7 may further comprise a liquid supply 140, a liquid path 143, comprising inlet liquid path 141 and return liquid path 142, a thermal control fluid supply 240T and a thermal control fluid path 243T, comprising thermal control fluid path 241T and a thermal control fluid path 242T. Likewise, the actuator component 1000 may comprise one or more liquid chambers 131 and one or more thermal control fluid channels 231T, etc. as described herein.

The droplet ejection apparatus 7 may further comprise one or more temperature sensors (not shown). The temperature sensors may be provided in the thermal control fluid path 243 and/or in the liquid path 143. They may be provided adjacent to the thermal control fluid supply 240 and/or adjacent to the liquid supply 140. They may be provided on the inlet thermal control fluid path 241 and the thermal control fluid return path 242. Additionally or instead, they may be provided on the liquid supply path 141. For example the thermal control fluid path 243 may comprise temperature sensors at the inlet and/or outlet to the actuator component 100 and/or at the inlet and/or outlet to the droplet ejection head. Likewise the liquid path 143 may comprise a temperature sensor on the liquid path 143 and/or at the inlet to the actuator component 100 and/or the inlet to the droplet ejection head. Where the thermal control fluid path 243 comprises a thermal control device 247 and/or a reservoir 246b, there may be one or more temperature sensors adjacent to the thermal control device 247 and/or the reservoir 246b.

The temperature measurements may be provided to a controller (not shown). The controller may control the droplet ejection apparatus 1 so as to adjust the temperature of the liquid. For example, the controller may control the thermal control fluid supply 240 to alter the flow rate of the thermal control fluid. Further the controller may control a thermal control device 247 to heat or cool the thermal control fluid. The controller may, for example, use a look-up table or a calibration routine to determine the required temperature and/or flow rate of the thermal control fluid to give a desired liquid temperature.

The droplet ejection head 1002 may comprise one or more actuator components 1000. It may be generally understood that any through-flow enabled actuator component described herein may be used in the droplet ejection apparatus 7, and in the droplet ejection head 1002, for thermal control of the fluid in the fluid chambers 131 and/or, where gas orifices 231 are also present in the actuator component, control of the ejected droplets as described herein. It may be generally understood that any of the actuator components 100-700 described herein may be modified to form a thermal control fluid path 243T, where the thermal control fluid is a gas or a liquid. Depending on the type of thermal control fluid and the desired operating conditions it may be understood that the orifices 231 may be retained or omitted. The thermal control fluid path 243T may comprise one or more thermal control fluid devices 247T such as heaters and/or coolers.

An actuator component for thermal control as described above may be described using the following numbered clauses:
1. An actuator component 100-1000 for a droplet ejection head comprising:
   an actuator assembly 80 and a nozzle plate 70;
   wherein said actuator assembly 80 comprises a plurality of liquid chambers 131 arranged in a liquid chamber array 130 extending in an array direction 10;
   and a plurality of thermal control fluid channels 231 arranged in a thermal control fluid channel array 230 extending in said array direction 10;
   wherein said plurality of liquid chambers 131 and said plurality of thermal control fluid channels 231 are fluidically independent;
   wherein said plurality of liquid chambers 131 are arranged to be fluidically connectable to a liquid supply 140;
   wherein said plurality of thermal control fluid channels are arranged to be fluidically connectable to a thermal control fluid supply 240;
   wherein said nozzle plate 70 comprises a plurality of droplet ejection nozzles 121 arranged in a nozzle array 120 extending in the array direction 10;
   wherein each liquid chamber 131 is arranged to be fluidically connected to one or more of said droplet ejection nozzles 121 and actuable for ejection of droplets of a liquid;
   wherein said plurality of thermal control fluid channels 231 and said plurality of liquid chambers 131 are arranged in a repeating pattern extending in the array direction 10; and
   wherein said actuator component 100-1000 is configured such that in use thermal control fluid flowing through said thermal control fluid channels 231 controls the thermal properties of the liquid flowing through said liquid chambers 131 to thereby control the thermal properties of the liquid ejected from said droplet ejection nozzles 121.
2. The actuator component 100-1000 according to Clause 1, wherein said liquid chambers 131 are elongate in a direction non-parallel to the array direction 10.
3. The actuator component 100-1000 according to Clause 1 or Clause 2, wherein said thermal control fluid channels 231 are elongate in a direction non-parallel to the array direction 10.
4. The actuator component 100-1000 according to any preceding Clause, wherein said thermal control fluid channels 231 have a greater height than said liquid chambers 131 in the liquid chamber height direction 15 so as to achieve said fluidic independence.
5. The actuator component 100-1000 according to any preceding Clause, further comprising one or more liquid manifolds 101, 102 and one or more thermal control fluid manifolds 201T,202T wherein said one or more liquid manifolds 101,102 are fluidically independent from said one or more thermal control fluid manifolds 201T,202T.
6. The actuator component 100-1000 according to Clause 5, wherein said one or more liquid manifolds 101,102 are fluidically independent from said plurality of thermal control fluid channels 231T.
7. The actuator component 100-1000 according to Clause 5 or Clause 6, wherein said one or more thermal control fluid manifolds 201T,202T are fluidically independent from said plurality of liquid chambers 131.
8. The actuator component according to any of Clauses 5 to 7, wherein said thermal control fluid channels 231T are fluidically connectable via at least one of said one or more thermal control fluid manifolds 201T,202T to said thermal control fluid supply 240T.
9. The actuator component 100-1000 according to any of Clauses 5 to 8, comprising two or more thermal control fluid manifolds 201T,202T arranged such that a first of said thermal control fluid manifolds 201T is fluidically connected to a first end of a plurality of thermal control fluid channels 231T and such that a second one of said two or more thermal control fluid manifolds 202T is fluidically connected to a second opposite end of the plurality of thermal control fluid channels 231T such that in use thermal control fluid flows from said first thermal control fluid control manifold 201T, along the plurality of thermal control fluid channels 231T from said first end to said second end and into said second thermal control fluid manifold 202T.
10. The actuator component 100-1000 according to any preceding Clause, wherein said liquid chambers 131 and said thermal control fluid channels 231T are arranged parallel to each other.
11. The actuator component 100-1000 according to any preceding Clause, wherein said thermal control fluid channels 231T and said liquid chambers 131 are arranged in an alternating relationship extending in said array direction 10.
12. The actuator component 100-1000 according to any preceding Clause, wherein said thermal control fluid channels 231T are provided with drive electrodes and/or electrical traces.
13. The actuator component 100-1000 according to any preceding Clause, wherein said thermal control fluid channels 231T are narrower than said liquid chambers 131 in the array direction 10.
14. A droplet ejection head comprising one or more actuator components 100-1000 according to any of Clauses 1 to 13.
15. A droplet ejection apparatus 1,2,7,9 comprising one or more actuator components 100-1000 according to any of Clauses 1 to 13 or one or more droplet ejection heads according to Clause 14, and further comprising a liquid supply 140 and a liquid path 143 and a thermal control fluid path 243T.
16. The droplet ejection apparatus 1,2,7,9 according to Clause 15, further comprising a thermal control fluid supply 240T.
17. The droplet ejection apparatus 1,2,7,9 according to Clause 15 or Clause 16, wherein said thermal control fluid path 243T comprises a return thermal control fluid path 242T.
18. The droplet ejection apparatus 1,2,7,9 according to any of Clauses 15 to Clause 17, wherein said liquid path 143 comprises a return liquid path 142.
19. The droplet ejection apparatus 1,2,7,9 according to any of Clauses 15 to Clause 18, further comprising a thermal control fluid reservoir 246bT.
20. The droplet ejection apparatus 1,2,7,9 according to any of Clauses 15 to Clause 19, wherein the fluid paths 143,243T are arranged such that in use thermal control fluid flows along the thermal control fluid channels 231T in a direction that is opposite to the direction of flow of the liquid in the liquid chambers 131.
21. The droplet ejection apparatus 1,2,7,9 according to any of Clauses 15 to 20, further comprising one or more thermal control devices 247T.
22. A method of operating a droplet ejection apparatus 1,2,7,9 according to any of Clauses 15 to 21, comprising:
   ejecting droplets of liquid from one or more of said droplet ejection nozzles 121 in accordance with printing instructions; and
   flowing thermal control fluid through said thermal control fluid channels 231T so as to control by thermal transfer the thermal properties of said liquid flowing through said liquid chambers 131 and thereby to control the thermal properties of the liquid ejected from said droplet ejection nozzles 121.
23. The method according to Clause 22, wherein said liquid is a liquid for droplet ejection.
24. The method according to Clause 22 or Clause 23, wherein said thermal control fluid is a liquid.
25. The method according to Clause 22 or Clause 23, wherein said liquid and said thermal control fluid are fed from a common liquid supply 140.
26. The method according to any of Clauses 22 to Clause 25, wherein the flow rates of said liquid and said thermal control fluid flowing through said droplet ejection apparatus 1,2,7,9 are controlled independently.
27. The method according to any of Clauses 22 to Clause 26, wherein the temperatures of said liquid and said thermal control fluid flowing through said droplet ejection apparatus 1,2,7,9 are controlled independently.
28. The method according to any of Clauses 22 to Clause 27, wherein said thermal control fluid comprises one or more of the following: atmospheric air, air heated above or cooled below ambient temperatures, humid air where the humidity is greater than ambient, dehumidified air where the humidity is less than ambient, inert gases, noble gases.
29. The method according to any of Clauses 22 to Clause 27, wherein said thermal control fluid comprises a refrigerant fluid.
30. The method according to any of Clauses 22 to Clause 27, wherein said thermal control fluid comprises water.
31. The method according to any of Clauses 23 to Clause 27, when dependent on Clause 23, wherein said thermal control fluid comprises said liquid for droplet ejection.
32. A method of manufacturing an actuator component 100-1000 for a droplet ejection head, wherein said method comprises the steps of:
   forming an actuator assembly 80, comprising:
   forming one or more arrays 130 of liquid chambers 131 in one or more strips of piezoelectric material 82 extending in an array direction 10,
      wherein each of said liquid chambers 131 forms an open channel in the strip of piezoelectric material 82 being open in a liquid chamber height direction 15 and open at a first end and a second end in a liquid chamber extension direction 5;
   forming one or more arrays of thermal control fluid channels 231T in said one or more strips of piezoelectric material 82 extending in said array direction 10,
      wherein each of said thermal control fluid channels 231T forms an open channel in the strip of piezoelectric material 82 being open in the liquid chamber height direction 15 and open at a first end and a second end in the liquid chamber extension direction 5;
      wherein said liquid chamber array 130 and said thermal control fluid channel 230T array are fluidically independent from each other; and
   fixedly attaching a nozzle plate 70 to the actuator assembly 80;
   forming droplet ejection nozzles 121 in said nozzle plate 70 either before or after the step of fixedly attaching the nozzle plate 70 to the actuator assembly 80 such that when assembled said actuator component comprises droplet ejection nozzles 121 fluidically connected to said liquid chambers 131.
33. The method according to Clause 32, further comprising
   forming one or more cut-outs 81 in either a substrate 83 and/or said strip of piezoelectric material 82;
   fixedly attaching said one or more strips of piezoelectric material 82 to said substrate 83 such that each of said one or more cut-outs 81 is arranged adjacent to the interface between the substrate 83 and a respective strip of piezoelectric material 82 so as to form one or more thermal control fluid manifolds 201T,202T,
      wherein each of said one or more arrays 130 of liquid chambers 131 are fluidically separated from said one or more thermal control fluid manifolds 201T,202T; and
      wherein each of said one or more arrays 230T of thermal control fluid channels 231T are fluidically connected to at least one of said one or more thermal control fluid manifolds 201T,202T.
34. The method according to Clause 32 or Clause 33, further comprising:
   fixedly attaching a first cover part 84_a to each of said one or more strips of piezoelectric material 82 at a first end in said liquid chamber extension direction 5.
35. The method according to Clause 34, further comprising:
   selectively forming a plurality of apertures 85 in said first cover parts 84 wherein said first cover parts 84 comprise at least one aperture 85 per liquid chamber 131 over a substantial portion of the array of liquid chambers 131.
36. The method according to Clause 35, wherein fixedly attaching said nozzle plate 70 comprises attaching it to the strip of piezoelectric material 82 at a second end in the liquid chamber extension direction 5 such that said nozzle plate 70 acts to fluidically seal said thermal control fluid channels 231T and said liquid chambers 131 in said liquid chamber extension direction 5.
37. The method according to Clause 34, further comprising:
   fixedly attaching a second cover part 84_b to each of said one or more strips of piezoelectric material 82 at a second opposite end in the liquid chamber extension direction 5.
38. The method according to Clause 37, further comprising:
   selectively forming a plurality of apertures 85 in said first and second cover parts 84 wherein said first and second cover parts 84 comprise at least one aperture per liquid chamber 131 over a substantial portion of the array of liquid chambers 130.
39. The method according to Clause 38, wherein fixedly attaching said nozzle plate 70 comprises attaching it to the strip of piezoelectric material 82 at one side in the liquid chamber height direction 15 such that said nozzle plate 70 acts to fluidically seal said thermal control fluid channels 231T and said liquid chambers 131 in said liquid chamber height direction 15.
40. An actuator component 100-1000 for a droplet ejection head comprising:
   an actuator assembly 80 and a nozzle plate 70;
   wherein said actuator assembly 80 comprises a plurality of liquid chambers 131 arranged in a liquid chamber array extending in an array direction;
   wherein said plurality of liquid chambers 131 are arranged to be fluidically connectable to a liquid supply;
   wherein said nozzle plate 70 comprises a plurality of droplet ejection nozzles 121 arranged in a nozzle array 120 extending in the array direction 10;
   wherein each liquid chamber 131 is arranged to be fluidically connected to one or more of said droplet ejection nozzles 121 and actuable for ejection of droplets of a liquid;
   wherein said actuator assembly 80 further comprises two or more liquid manifolds 101,102 arranged below said liquid chambers 131 in a liquid chamber height direction 15;
   wherein a first of said liquid manifolds 101 is fluidically connected to one end of a plurality of liquid chambers 131 in a liquid chamber extension direction 5;
   wherein a second one of said two or more liquid manifolds 102 is fluidically connected to a second opposite end of the plurality of liquid chambers 131 in the liquid chamber extension direction 5; and
   arranged such that in use liquid flows from said first liquid manifold 101 along the plurality of liquid chambers 131 from said first end to said second end and into said second manifold 102.
41. The actuator component 100-1000 according to Clause 40, wherein said actuator assembly 80 comprises one or more strips of piezoelectric material 82 and a substrate 83 and wherein said two or more liquid manifolds 101,102 comprise one or more cut-outs 81 in either the substrate 83 and/or said one or more strips of piezoelectric material 82.
42. The actuator component 100-1000 according to Clause 40 or Clause 41, wherein said actuator assembly 80 comprises a plurality of thermal control fluid channels 231T arranged in a thermal control fluid channel array 230T extending in an array direction 10 configured such that in use thermal control fluid flowing through said thermal control fluid channels 231 controls the thermal properties of the liquid flowing through said liquid chambers 131 to thereby control the thermal properties of the liquid ejected from said droplet ejection nozzles 121.

1. An actuator component for a droplet ejection head, the actuator component comprising:
an actuator assembly and a nozzle plate;
wherein said actuator assembly includes a plurality of liquid chambers arranged in a liquid chamber array extending in an array direction;
wherein said plurality of liquid chambers are configured to be fluidically connectable to a liquid supply; and
said actuator assembly further including a plurality of gas channels arranged in a gas channel array extending in said array direction;
wherein said plurality of gas channels are configured to be fluidically connectable to a gas supply;
wherein said liquid chamber array and said gas channel array are fluidically independent from each other;
wherein said nozzle plate includes a plurality of droplet ejection nozzles arranged in a nozzle array extending in the array direction;
said nozzle plate further including a plurality of gas orifices arranged in an orifice array extending in the array direction;
wherein said gas orifices and said droplet ejection nozzles are arranged in a repeating pattern extending in the array direction;
wherein each of said liquid chambers is fluidically connected to one or more of said droplet ejection nozzles and is configured to be actuable for ejection of droplets of a liquid through said one or more droplet ejection nozzles;
wherein said plurality of gas channels are fluidically connected to respective one or more of said gas orifices for flow of a gas; and
whereby in use of said actuator component gas flowing through said gas orifices controls one or more properties of liquid ejected from said droplet ejection nozzles.

2. The actuator component for a droplet ejection head according to claim 1 wherein said gas orifices have an elongate shape.

3. The actuator component for a droplet ejection head according to claim 1 wherein said gas orifices have substantially the same shape as said droplet ejection nozzles.

4. The actuator component for a droplet ejection head according to claim 1, the actuator component further comprising plural gas orifices per droplet ejection nozzle.

5. The actuator component for a droplet ejection head according to claim 4, wherein said plural gas orifices per droplet ejection nozzle are spaced apart from the nozzle centre in the array direction, or
wherein said plural gas orifices per droplet ejection nozzle are spaced apart from the nozzle centre in the liquid chamber extension direction.

6. (canceled)

7. The actuator component for a droplet ejection according to claim 1, wherein one or more droplet ejection nozzles comprise at least two gas orifices per droplet ejection nozzle spaced apart from the nozzle centre in the array direction and at least two gas orifices per droplet ejection nozzle spaced apart from the nozzle centre in the liquid chamber extension direction, such that the droplet ejection nozzle is substantially surrounded by the gas orifices.

8. The actuator component for a droplet ejection head according claim 1, wherein the centres of substantially all of said gas orifices are spaced apart from the centre of the nearest droplet ejection nozzle by a nozzle spacing ns/2 in the array direction.

9. (canceled)

10. (canceled)

11. The actuator component for a droplet ejection head claim 1, wherein said gas channels are deeper than said liquid chambers in said liquid chamber height direction so as to achieve said fluidic independence.

12-15. (canceled)

16. The actuator component for a droplet ejection head according to claim 1, the actuator component further comprising one or more gas manifolds;
wherein said gas channels are fluidically connectable via said one or more gas manifolds to said gas supply.

17. (canceled)

18. The actuator component for a droplet ejection head according to claim 1, wherein said gas channels are narrower in the array direction than said liquid chambers.

19. (canceled)

20. A droplet ejection apparatus comprising:
an actuator components, the actuator component including an actuator assembly and a nozzle plate:
wherein said actuator assembly includes a plurality of liquid chambers arranged in a liquid chamber array extending in an array direction;
wherein said plurality of liquid chambers are configured to be fluidically connectable to a liquid supply; and
said actuator assembly further including a plurality of gas channels arranged in a gas channel array extending in said array direction;
wherein said plurality of gas channels are configured to be fluidically connectable to a gas supply:
wherein said liquid chamber array and said gas channel array are fluidically independent from each other;
wherein said nozzle plate includes a plurality of droplet ejection nozzles arranged in a nozzle array extending in the array direction;
said nozzle plate further including a plurality of gas orifices arranged in an orifice array extending in the array direction;
wherein said gas orifices and said droplet ejection nozzles are arranged in a repeating pattern extending in the array direction:
wherein each of said liquid chamber is fluidically connected to one or more of said droplet ejection nozzles and is configured to be actuable for ejection of droplets of a liquid through said one or more droplet ejection nozzles;
wherein said plurality of gas channels are fluidically connected to respective one or more of said gas orifices for flow of a gas; and
whereby in use of said actuator component gas flowing through said gas orifices controls one or more properties of liquid ejected from said droplet ejection nozzles; and
the droplet ejection apparatus further including a liquid supply and a gas supply, wherein said gas supply is arranged to be a positive gas supply or negative gas supply.

21. A method of operating a droplet ejection apparatus according to claim 20 comprising:
ejecting droplets of liquid from one or more of said droplet ejection nozzles in accordance with printing instructions; and
flowing gas through said gas orifices so as to control the droplets of said liquid ejected from said droplet ejection nozzles.

22. The method according to claim 21 wherein said method further comprises arranging said gas supply to be a negative gas supply so as to draw gas through said gas orifices into said actuator component.

23. The method according to claim 21 wherein said method further comprises arranging said gas supply to be a positive gas supply so as to supply gas to said actuator component so as to flow gas from said actuator component through said gas orifices.

24. (canceled)

25. (canceled)

26. The method according to claim 21, wherein said gas comprises one or more of the following: atmospheric air, air heated above or cooled below ambient temperatures, humid air where the humidity is greater than ambient, dehumidified air where the humidity is less than ambient, inert gases, solvent used as a component of said liquid in gaseous form.

27. The method according to claim 21, wherein said flowing of said gas through said gas orifices is substantially continuous.

28. The method according to claim 21, wherein the droplet ejection velocity is controlled as a function of the gas velocity flowing through said gas orifices.

29. The method according to claim 21, wherein the gas velocity as it flows through said gas orifices is adjusted as a function of the droplet ejection velocity.

30. The method according to claim 21, wherein the gas velocity as it flows through said gas orifices is greater than a droplet ejection velocity.

31. A method of manufacturing an actuator component for a droplet ejection head, wherein said method comprises the steps of:
forming an actuator assembly, comprising:
forming one or more arrays of liquid chambers in one or more strips of piezoelectric material extending in an array direction,
wherein each of said liquid chambers forms an open channel in the strip of piezoelectric material being open in a liquid chamber height direction and open at both ends in a liquid chamber extension direction;
forming one or more arrays of gas channels in said one or more strips of piezoelectric material extending in said array direction,
wherein each of said gas channels forms an open channel in the strip of piezoelectric material being open in the liquid chamber height direction and open at both ends in the liquid chamber extension direction;
wherein said liquid chamber array and said gas channel array are fluidically independent from each other; and
fixedly attaching a nozzle plate to the actuator assembly;
forming droplet ejection nozzles and gas orifices in said nozzle plate either before or after the step of fixedly attaching the nozzle plate to the actuator assembly such that when assembled said actuator component comprises droplet ejection nozzles fluidically connected to said liquid chambers and gas orifices fluidically connected to said gas channels,
wherein said gas orifices and said droplet ejection nozzles are arranged in a repeating pattern extending in the array direction.

32-37. (canceled)
